(19) United States
(12) Patent Application Publication
(10) Pub. No.: US 2026/0303151 A1
(43) Pub. Date: Oct. 1, 2026

(54) USER EQUIPMENT CONTROL OF RECONFIGURABLE INTELLIGENT SURFACE

(71) Applicant: QUALCOMM Incorporated, San Diego, CA (US)

(72) Inventors: Mingxi YIN, Beijing (CN); Min HUANG, Beijing (CN); Hao XU, Beijing (CN)

(21) Appl. No.: 19/476,047

(22) PCT Filed: Jun. 9, 2023
(86) PCT No.: PCT/CN2023/099270

§ 371 Date: Oct. 16, 2025

(51) Int. Cl. H04B 7/04; H04W 74/0833

(52) U.S. Cl. CPC H04B 7/04013; H04W 74/0833

(57) ABSTRACT

Various aspects of the present disclosure generally relate to wireless communication. In some aspects, a user equipment (UE) may receive, from a network node via a reconfigurable intelligent surface (RIS), a synchronization signal block (SSB). The UE may establish, based at least in part on receiving the SSB, a network connection with the network node, wherein establishing the network connection includes performing a random access procedure via the RIS and transmitting a control signal for controlling the RIS. Numerous other aspects are described.

### FIELD OF THE DISCLOSURE

Aspects of the present disclosure generally relate to wireless communication and to techniques and apparatuses for user equipment (UE) control of a reconfigurable intelligent surface (RIS).

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### BRIEF DESCRIPTION OF THE DRAWINGS

So that the above-recited features of the present disclosure can be understood in detail, a description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIG. 4 is a diagram illustrating an example of a four-step random access procedure, in accordance with the present disclosure.

FIG. 5 is a diagram illustrating an example of a two-step random access procedure, in accordance with the present disclosure.

FIG. 6 is a diagram illustrating an example of communications using a reconfigurable intelligent surface (RIS), in accordance with the present disclosure.

FIG. 7 is a diagram illustrating an example of communication links in a wireless network that includes a RIS, in accordance with the present disclosure.

FIG. 8 is a diagram illustrating an example involving a RIS, in accordance with the present disclosure.

FIG. 9 is a diagram illustrating an example involving a RIS controller, in accordance with the present disclosure.

FIG. 10 is a diagram illustrating an example of a RIS that is non-transparent to a network and controlled by a UE that is in-coverage with a network node, in accordance with the present disclosure.

FIG. 11 is a diagram illustrating an example of a RIS that is non-transparent to a network and controlled by a UE that is out-of-coverage with a network node, in accordance with the present disclosure.

FIG. 12 is a diagram illustrating an example associated with UE control of a RIS, in accordance with the present disclosure.

FIG. 13 is a diagram illustrating an example of two-sided beam-sweeping for an out-of-coverage UE, in accordance with the present disclosure.

FIG. 14 is a diagram illustrating an example of timing associated with two-sided beam-sweeping for an out-of-coverage UE, in accordance with the present disclosure.

FIG. 15 is a diagram illustrating examples of a timing issue related to two-sided beam-sweeping involving a random access channel (RACH) procedure, in accordance with the present disclosure.

FIG. 16 is a diagram illustrating an example of a four-step random access procedure that integrates a RIS control authorization procedure, in accordance with the present disclosure.

FIG. 17 is a diagram illustrating an example of a two-step random access procedure that integrates a RIS control authorization procedure, in accordance with the present disclosure.

FIG. 18 is a diagram illustrating examples that avoid quasi-colocation (QCL) of synchronization signal blocks (SSBs), in accordance with the present disclosure.

FIG. 19 is a diagram illustrating an example of multi-UE support for a RIS, in accordance with the present disclosure.

FIG. 20 is a diagram illustrating an example of multi-UE support for a RIS using space division multiplexing (SDM) and an example of multi-UE support for a RIS using time division multiplexing (TDM), in accordance with the present disclosure.

FIG. 21 is a diagram illustrating an example process performed, for example, by a UE, in accordance with the present disclosure.

FIG. 22 is a diagram illustrating an example process performed, for example, by a network node, in accordance with the present disclosure.

FIG. 23 is a diagram of an example apparatus for wireless communication, in accordance with the present disclosure.

FIG. 24 is a diagram of an example apparatus for wireless communication, in accordance with the present disclosure.

### SUMMARY

Some aspects described herein relate to a user equipment (UE) for wireless communication. The UE may include one or more memories and one or more processors coupled to the one or more memories. The one or more processors may be configured to receive, from a network node via a reconfigurable intelligent surface (RIS), a synchronization signal block (SSB). The one or more processors may be configured to establish, based at least in part on receiving the SSB, a network connection with the network node, wherein the one or more processors, to establish the network connection, are configured to perform a random access procedure via the RIS and transmit a control signal for controlling the RIS.

Some aspects described herein relate to a network node for wireless communication. The network node may include one or more memories and one or more processors coupled to the one or more memories. The one or more processors may be configured to output an SSB. The one or more processors may be configured to establish, based at least in part on the SSB, a network connection with a UE, wherein the one or more processors, to establish the network connection, are configured to perform a random access procedure via a RIS configured to be controlled by the UE.

Some aspects described herein relate to a method of wireless communication performed by a UE. The method may include receiving, from a network node via a RIS, an SSB. The method may include establishing, based at least in part on receiving the SSB, a network connection with the network node, wherein establishing the network connection includes performing a random access procedure via the RIS and transmitting a control signal for controlling the RIS.

Some aspects described herein relate to a method of wireless communication performed by a network node. The method may include outputting an SSB. The method may include establishing, based at least in part on the SSB, a network connection with a UE, wherein establishing the network connection includes performing a random access procedure via a RIS configured to be controlled by the UE.

Some aspects described herein relate to a non-transitory computer-readable medium that stores a set of instructions for wireless communication by a UE. The set of instructions, when executed by one or more processors of the UE, may cause the UE to receive, from a network node via a RIS, an SSB. The set of instructions, when executed by one or more processors of the UE, may cause the UE to establish, based at least in part on receiving the SSB, a network connection with the network node, wherein the set of instructions that causes the UE to establish the network connection may cause the UE to perform a random access procedure via the RIS and transmit a control signal for controlling the RIS.

Some aspects described herein relate to a non-transitory computer-readable medium that stores a set of instructions for wireless communication by a network node. The set of instructions, when executed by one or more processors of the network node, may cause the network node to output an SSB. The set of instructions, when executed by one or more processors of the network node, may cause the network node to establish, based at least in part on the SSB, a network connection with a UE, wherein the set of instructions that causes the network node to establish the network connection may cause the network node to perform a random access procedure via a RIS configured to be controlled by the UE.

Some aspects described herein relate to an apparatus for wireless communication. The apparatus may include means for receiving, from a network node via a RIS, an SSB. The apparatus may include means for establishing, based at least in part on receiving the SSB, a network connection with the network node, wherein the means for establishing the network connection includes means for performing a random access procedure via the RIS and means for transmitting a control signal for controlling the RIS.

Some aspects described herein relate to an apparatus for wireless communication. The apparatus may include means for outputting an SSB. The apparatus may include means for establishing, based at least in part on the SSB, a network connection with a UE, wherein the means for establishing the network connection includes means for performing a random access procedure via a RIS configured to be controlled by the UE.

Aspects generally include a method, apparatus, system, computer program product, non-transitory computer-readable medium, user equipment, base station, network entity, network node, wireless communication device, and/or processing system as substantially described herein with reference to and as illustrated by the drawing and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### DETAILED DESCRIPTION

A user equipment (UE) attempting to control a reconfigurable intelligent surface (RIS) may face challenges associated with establishing a network connection with a network node when the UE is out-of-coverage from the network node. Because the UE is out-of-coverage, the UE may be unable to communicate directly with the network node (e.g., to establish the network connection directly with the network node and/or to enable the UE to control the RIS). Moreover, before taking control of the RIS, the UE may be unable to establish the network connection with the network node.

In some examples, the UE may require authorization from the network node to control the RIS. However, being out-of-coverage, the UE can only reach the network node using the RIS. Therefore, the out-of-coverage UE may be unable to obtain a network authorization to control a RIS. Furthermore, the RIS may be unable to validate such a network authorization of the out-of-coverage UE, and the network authorization may not be secure.

Various aspects relate generally to RISs. Some aspects more specifically relate to providing UE control of RISs. In some examples, a network node may output, and the UE may receive, via the RIS, an SSB. The network node and the UE may establish a network connection with each other based at least in part on the SSB. In some aspects, the UE may transmit the control signal based at least in part on an authorization to control the RIS. For example, the UE may obtain the authorization while or after performing the random access procedure and may transmit the control signal after obtaining the authorization.

Aspects of the subject matter described in this disclosure can be implemented to realize one or more of the following potential advantages. In some examples, by establishing the network connection with each other based at least in part on the SSB, the described techniques can be used to enable the UE to communicate with the network node via the UE-controlled RIS. For example, the network node and the UE may establish the network connection even if the UE is out-of-coverage with the network node, thereby enabling an out-of-coverage UE to control a RIS and communicate with the network node. Furthermore, the authorization to control the RIS may enable the network node to centralize management and coordinate UE control of the RIS. For example, the authorization may enable the network node to avoid collisions when multiple UEs attempt to control the same RIS. The authorization may improve security and provide multiple UEs with an equal chance to access the network node.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

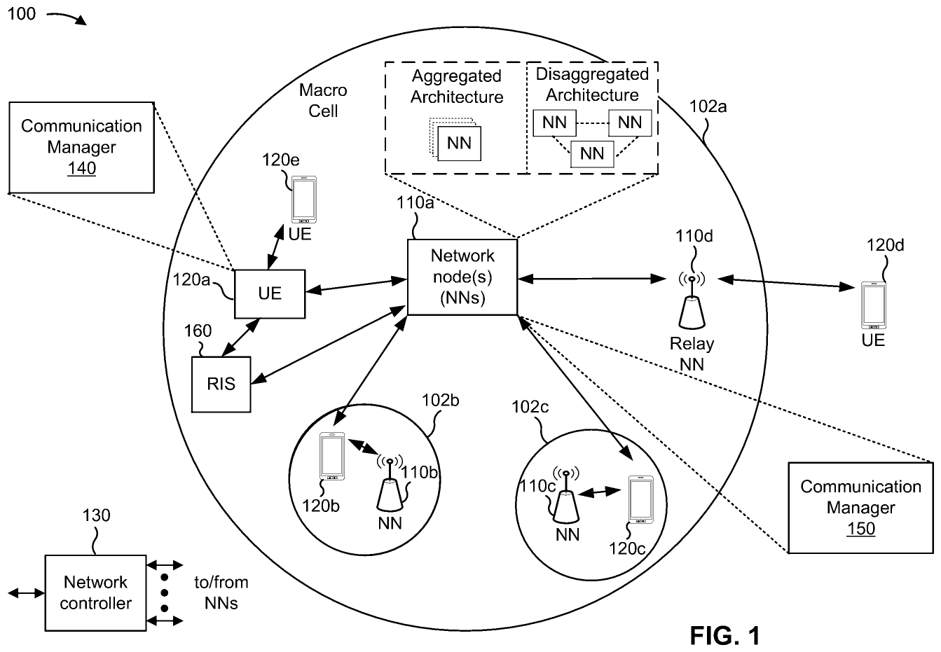

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, an unmanned aerial vehicle, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

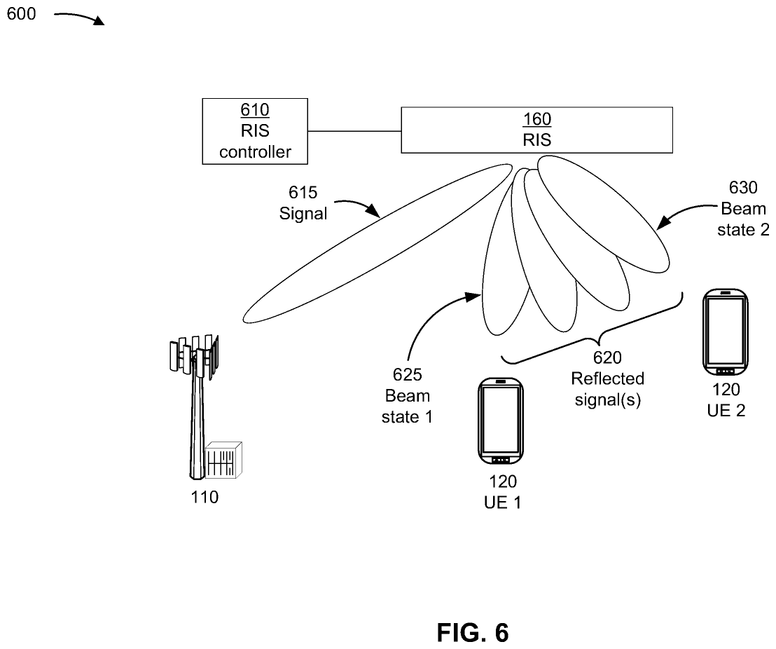

In some aspects, the wireless network 100 may also include a RIS 160. The RIS 160 may include a surface with a massive number of densely-placed reconfigurable meta-elements that can reflect or refract electromagnetic waves in target directions. As described in greater detail below in connection with FIGS. 6-9, the network node 110 and the UE 120 may use the RIS 160 to communicate with one another. For example, the RIS 160 may reflect or redirect a signal to the network node 110 and/or the UE 120. The RIS 160 may also be referred to as an intelligent reflecting surface. In some examples, the RIS 160 may be a repeater.

In some aspects, the UE 120 may include a communication manager 140. As described in more detail elsewhere herein, the communication manager 140 may receive, from a network node via the RIS 160, an SSB; and establish, based at least in part on receiving the SSB, a network connection with the network node 110, wherein establishing the network connection includes performing a random access procedure via the RIS 160 and transmitting a control signal for controlling the RIS 160. Additionally, or alternatively, the communication manager 140 may perform one or more other operations described herein.

In some aspects, the network node 110 may include a communication manager 150. As described in more detail elsewhere herein, the communication manager 150 may output an SSB; and establish, based at least in part on the SSB, a network connection with a UE 120, wherein establishing the network connection includes performing a random access procedure via a RIS 160 configured to be controlled by the UE 120. Additionally, or alternatively, the communication manager 150 may perform one or more other operations described herein.

As indicated above, FIG. 1 is provided as an example. Other examples may differ from what is described with regard to FIG. 1.

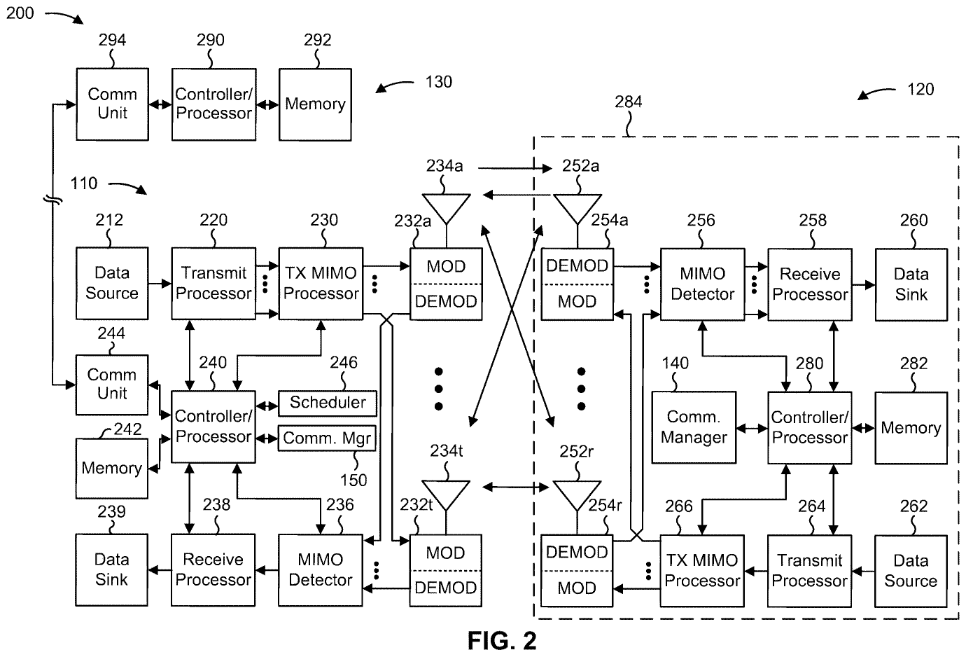

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

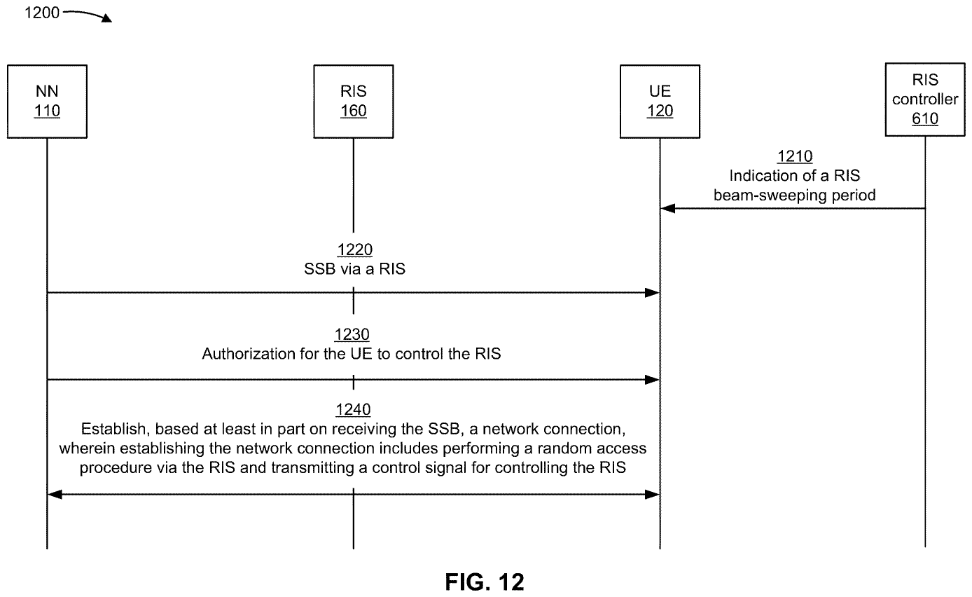

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 12-24).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 12-24).

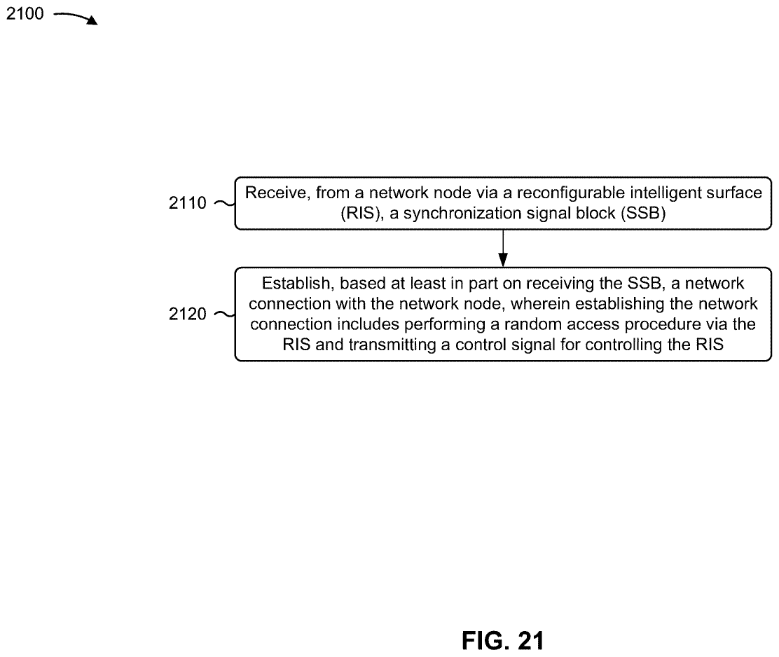

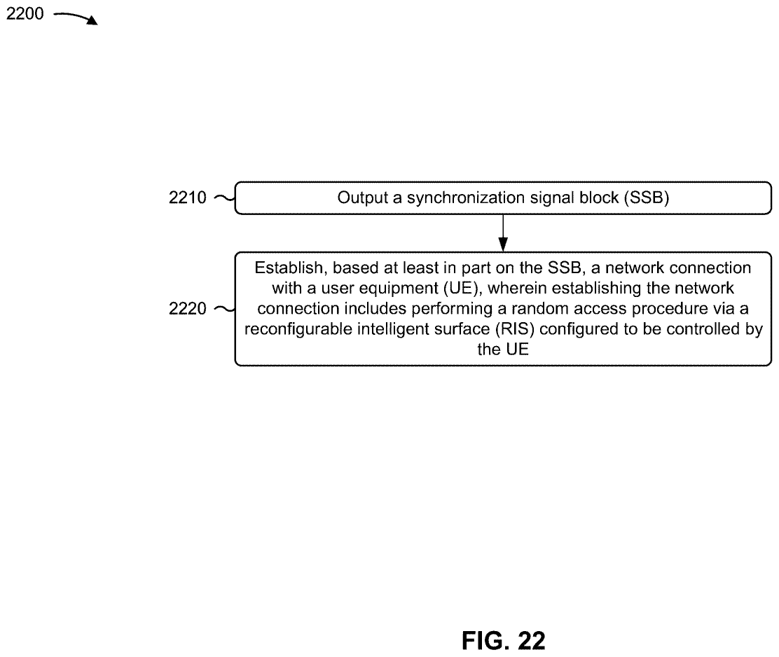

The controller/processor 240 of the network node 110, the controller/processor 280 of the UE 120, and/or any other component(s) of FIG. 2 may perform one or more techniques associated with UE control of a RIS, as described in more detail elsewhere herein. For example, the controller/processor 240 of the network node 110, the controller/processor 280 of the UE 120, and/or any other component(s) of FIG. 2 may perform or direct operations of, for example, process 2100 of FIG. 21, process 2200 of FIG. 22, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 2100 of FIG. 21, process 2200 of FIG. 22, and/or other processes as described herein. In some examples, executing instructions may include running the instructions, converting the instructions, compiling the instructions, and/or interpreting the instructions, among other examples.

In some aspects, the UE 120 includes means for receiving, from a network node via the RIS 160, an SSB; and/or means for establishing, based at least in part on receiving the SSB, a network connection with the network node 110, wherein the means for establishing the network connection may include means for performing a random access procedure via the RIS 160 and means for transmitting a control signal for controlling the RIS 160. The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the network node 110 includes means for outputting an SSB; and/or means for establishing, based at least in part on the SSB, a network connection with the UE 120, wherein establishing the network connection includes performing a random access procedure via the RIS 160 configured to be controlled by the UE 120. The means for the network node 110 to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

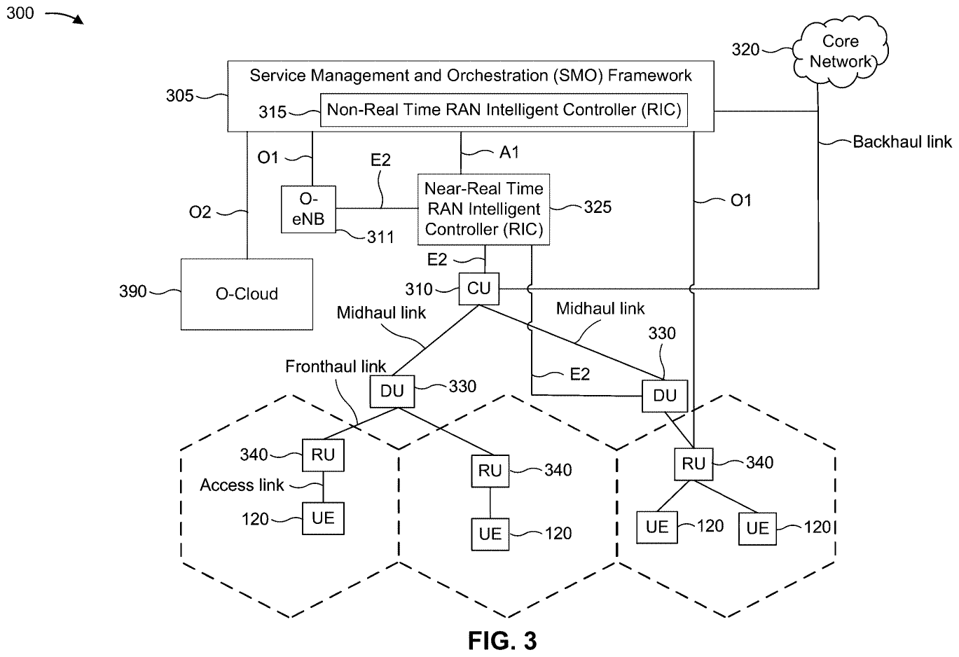

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

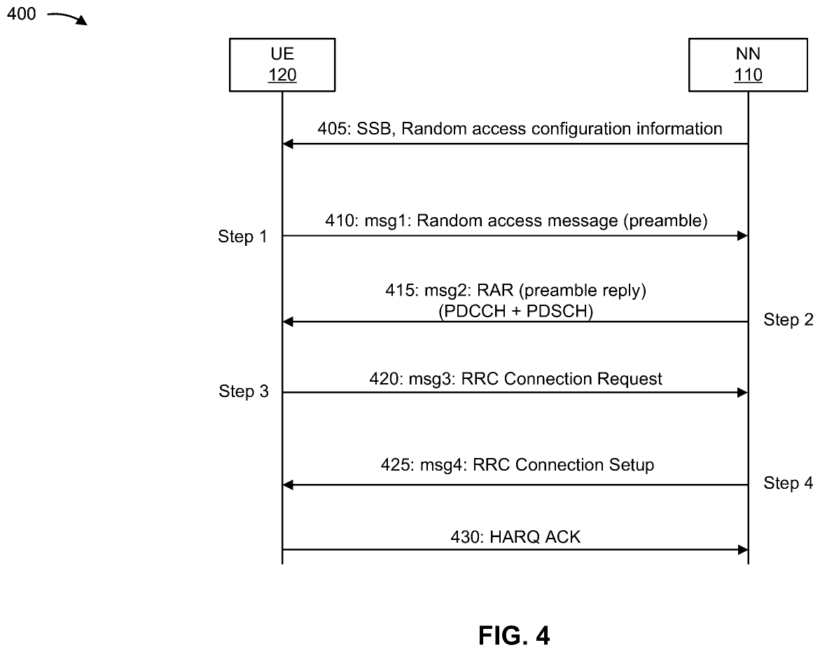

FIG. 4 is a diagram illustrating an example of a four-step random access procedure, in accordance with the present disclosure. As shown in FIG. 4, a network node 110 and a UE 120 may communicate with one another to perform the four-step random access procedure.

As shown by reference number 405, the network node 110 may transmit, and the UE 120 may receive, one or more SSBs and random access configuration information. In some aspects, the random access configuration information may be transmitted in and/or indicated by system information (e.g., in one or more system information blocks (SIBs)) and/or an SSB, such as for contention-based random access. Additionally, or alternatively, the random access configuration information may be transmitted in an RRC message and/or a physical downlink control channel (PDCCH) order message that triggers a RACH procedure, such as for contention-free random access. The random access configuration information may include one or more parameters to be used in the random access procedure, such as one or more parameters for transmitting a random access message (RAM) and/or one or more parameters for receiving a random access response (RAR).

As shown by reference number 410, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 415, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a physical downlink shared channel (PDSCH) communication that includes the RAR. For example, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 420, the UE 120 may transmit an RRC connection request message. The RRC connection request message may be referred to as message 3, msg3, MSG3, or a third message of a four-step random access procedure. In some aspects, the RRC connection request may include a UE identifier, uplink control information (UCI), and/or a physical uplink shared channel (PUSCH) communication (e.g., an RRC connection request).

As shown by reference number 425, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information. As shown by reference number 430, if the UE 120 successfully receives the RRC connection setup message, the UE 120 may transmit a hybrid automatic repeat request (HARQ) acknowledgement (ACK).

As indicated above, FIG. 4 is provided as an example. Other examples may differ from what is described with regard to FIG. 4.

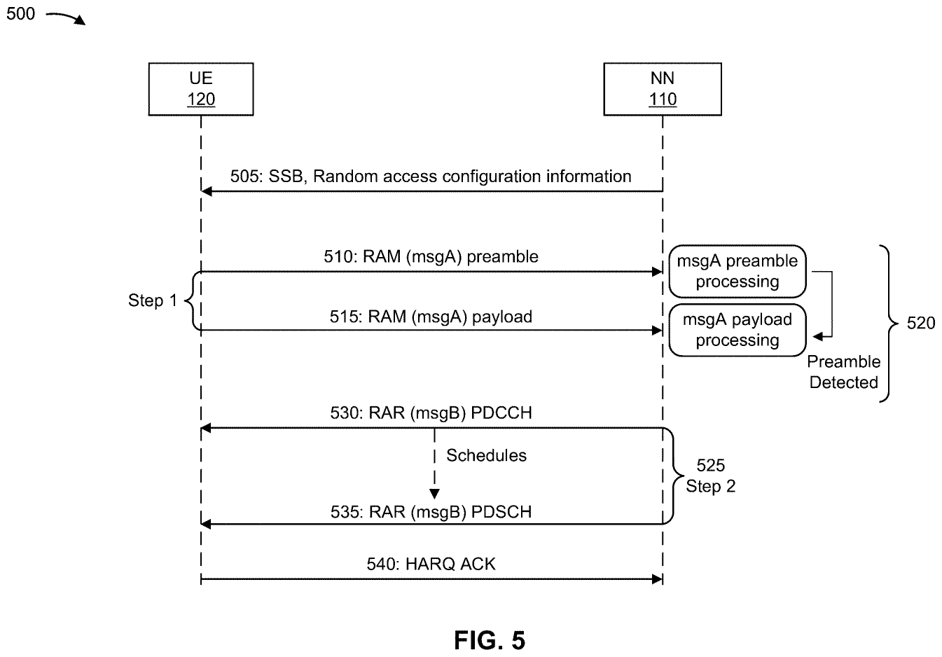

FIG. 5 is a diagram illustrating an example 500 of a two-step random access procedure, in accordance with the present disclosure. As shown in FIG. 5, a network node 110 and a UE 120 may communicate with one another to perform the two-step random access procedure.

As shown by reference number 505, the network node 110 may transmit, and the UE 120 may receive, one or more synchronization signal blocks (SSBs) and random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure, such as one or more parameters for transmitting a RAM and/or receiving an RAR to the RAM.

As shown by reference number 510, the UE 120 may transmit, and the network node 110 may receive, a RAM preamble. As shown by reference number 515, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. For example, the RAM preamble may include some or all contents of message 1 (e.g., a PRACH preamble), and the RAM payload may include some or all contents of message 3 (e.g., a UE identifier, UCI, and/or a PUSCH transmission).

As shown by reference number 520, the network node 110 may receive the RAM preamble transmitted by the UE 120. If the network node 110 successfully receives and decodes the RAM preamble, the network node 110 may then receive and decode the RAM payload.

As shown by reference number 525, the network node 110 may transmit a RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of a four-step random access procedure. For example, the RAR message may include the detected PRACH preamble identifier, the detected UE identifier, a timing advance value, and/or contention resolution information.

As shown by reference number 530, as part of the second step of the two-step random access procedure, the network node 110 may transmit a PDCCH communication for the RAR. The PDCCH communication may schedule a PDSCH communication that includes the RAR. For example, the PDCCH communication may indicate a resource allocation (e.g., in downlink control information (DCI)) for the PDSCH communication.

As shown by reference number 535, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 540, if the UE 120 successfully receives the RAR, the UE 120 may transmit a HARQ ACK.

As indicated above, FIG. 5 is provided as an example. Other examples may differ from what is described with regard to FIG. 5.

FIG. 6 is a diagram illustrating an example 600 of communications using a RIS, in accordance with the present disclosure. As shown in FIG. 6, a network node 110 may communicate with a UE 120 in a wireless network, such as the wireless network 100. The network node 110 and the UE 120 may use the RIS 160 to communicate with one another. For example, the RIS 160 may reflect or redirect a signal to the network node 110 and/or the UE 120. The RIS 160 may also be referred to as an intelligent reflecting surface. In some examples, the RIS 160 may be a repeater.

The RIS 160 may be, or may include, a planar or two-dimensional structure or surface that is designed to have properties to enable a dynamic control of signals or electromagnetic waves reflected and/or redirected by the RIS 160. The RIS 160 may include one or more reconfigurable elements. For example, the RIS 160 may include an array of reconfigurable elements (e.g., an array of uniformly distributed reconfigurable elements). For example, the RIS 160 may be approximately 1 meter by 1.02 meters and include approximately 100 unit cells by 102 unit cells, corresponding to approximately 35 λ by 35.7 λ at 10.5 GHz, where λ is wavelength. The reconfigurable elements may be elements with a reconfigurable electromagnetic characteristic. For example, the electromagnetic characteristic may include a reflection characteristic (e.g., a reflection coefficient), a scattering characteristic, an absorption characteristic, and/or a diffraction characteristic. The electromagnetic characteristic(s) of each reconfigurable element may be independently controlled and changed over time. The electromagnetic characteristic(s) of each reconfigurable element may be independently configured such that the combination of configured states of the reconfigurable elements reflects an incident signal or waveform in a controlled manner. For example, the reconfigurable elements may be configured to reflect or redirect an impinging signal in a controlled manner, such as by reflecting the impinging signal in a desired direction, with a desired beam width, with a desired phase, with a desired amplitude, and/or with a desired polarization, among other examples. In other words, the RIS 160 may be capable of modifying one or more properties (e.g., direction, beam width, phase, amplitude, and/or polarization) of an impinging signal.

The reconfigurable elements of the RIS 160 may be controlled and/or configured by a RIS controller 610. The RIS controller 610 may be a control module (e.g., a controller and/or a processor) that is capable of configuring the electromagnetic characteristic(s) of each reconfigurable element of the RIS 160. The RIS controller 610 may be associated with certain components similar to the components described in connection with the UE 120 in connection with FIG. 2, such as a modem 254 and/or a similar component for purposes of communicating with a network node 110. The RIS controller 610 may receive control communications (e.g., from a network node 110 and/or a UE 120) indicating one or more properties of reflected signals (e.g., indicating a desired direction, a desired beam width, a desired phase, a desired amplitude, and/or a desired polarization). Therefore, in some examples, the RIS 160 may be capable of receiving communications (e.g., via the RIS 160 and/or the RIS controller 610). In some examples, the RIS 160 and/or the RIS controller 610 may not have transmit capabilities (e.g., the RIS 160 may be capable of reflecting and/or redirecting impinging signals via the reconfigurable elements, but may not be capable of generating and/or transmitting signals). Alternatively, in some examples, the RIS 160 and/or the RIS controller 610 may have transmit capabilities (e.g., the RIS 160 may be capable of reflecting and/or redirecting impinging signals via the reconfigurable elements and may be capable of generating and/or transmitting signals). For example, the RIS 160 and/or the RIS controller 610 may include one or more antennas and/or antenna elements for receiving and/or transmitting signals.

For example, as shown in FIG. 6, the network node 110 may transmit a signal 615. The signal 615 may be transmitted in a spatial direction toward the RIS 160. The RIS 160 may configure the reconfigurable elements of the RIS 160 to reflect and/or redirect the signal 615 in a desired spatial direction and/or with one or more desired signal characteristics (e.g., beam width, phase, amplitude, frequency, and/or polarization). For example, as shown by reference number 620, the RIS 160 may be capable of reflecting the signal 615 in one or more spatial directions. Although multiple beams are shown in FIG. 6 representing different beam states or beam directions of the RIS 160, the RIS 160 may be capable of reflecting a signal with one beam state or one beam direction at a time. For example, in one case, as shown by reference number 625, the RIS 160 may be configured to reflect the signal 615 using a first beam state (e.g., beam state 1). “Beam state” may refer to a spatial direction and/or a beam of a reflected signal (e.g., a signal reflected by the RIS 160). The first beam state may cause the signal 615 to be reflected in a spatial direction toward a first UE 120 (e.g., UE 1). As shown by reference number 630, in another case, the RIS 160 may be configured to reflect the signal 615 using a second beam state (e.g., beam state 2). The second beam state may cause the signal 615 to be reflected in a spatial direction toward a second UE 120 (e.g., UE 2).

The RIS 160 may be deployed in a wireless network (such as the wireless network 100) to improve communication performance and efficiency. For example, the RIS 160 may enable a transmitter (e.g., a network node 110 or a UE 120) to control the scattering, reflection, and refraction characteristics of signals transmitted by the transmitter, to overcome the negative effects of wireless propagation. For example, the RIS 160 may effectively control signal characteristics (e.g., spatial direction, beam width, phase, amplitude, frequency, and/or polarization) of an impinging signal without a need for complex decoding, encoding, and radio frequency processing operations. Therefore, the RIS 160 may provide increased channel diversity for propagation of signals in a wireless network. The increased channel diversity provides robustness to channel fading and/or blocking, such as when higher frequencies are used by the network node 110 and/or the UE 120 (e.g., millimeter wave frequencies and/or sub-terahertz frequencies). Moreover, as the RIS 160 does not need to perform complex decoding, encoding, and radio frequency processing operations, the RIS 160 may provide a more cost and energy efficient manner of reflecting and/or redirecting signals in a wireless network (e.g., as compared to other mechanisms for reflecting and/or redirecting signals, such as a relay device).

As indicated above, FIG. 6 is provided as an example. Other examples may differ from what is described with respect to FIG. 6.

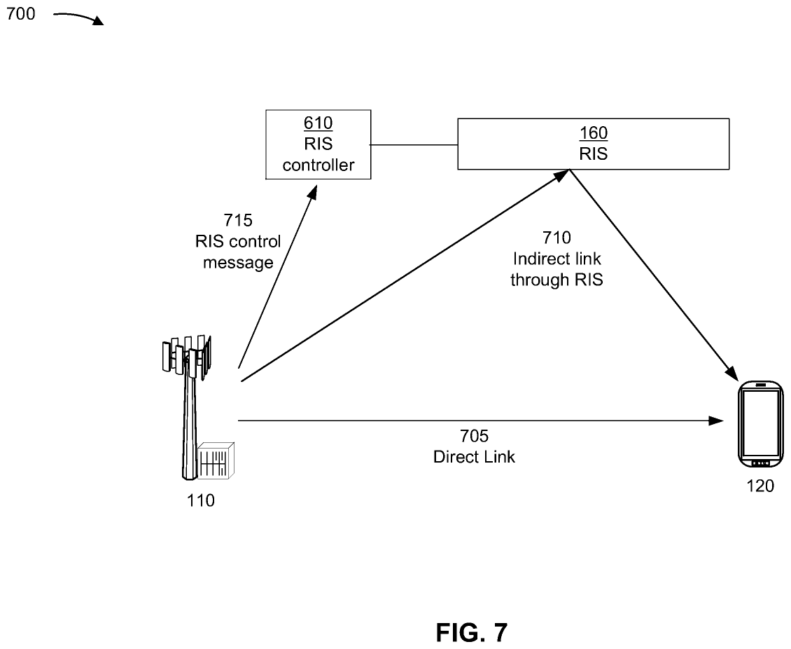

FIG. 7 is a diagram illustrating an example 700 of communication links in a wireless network that includes a RIS, in accordance with the present disclosure. As shown, example 700 includes a network node 110, a UE 120, and the RIS 160. The RIS 160 may be controlled and/or configured by the RIS controller 610.

As shown in FIG. 7, the UE 120 may receive a communication (e.g., data and/or control information) directly from the network node 110 as a downlink communication. Additionally, or alternatively, the UE 120 may receive a communication (e.g., data and/or control information) indirectly from the network node 110 via the RIS 160. For example, the network node 110 may transmit the communication in a spatial direction toward the RIS 160, and the RIS 160 may redirect or reflect the communication to the UE 120.

In some examples, the UE 120 may communicate directly with the network node 110 via a direct link 705. For example, a communication may be transmitted via the direct link 705. A communication transmitted via the direct link 705 between the UE 120 and the network node 110 does not pass through and is not reflected or redirected by the RIS 160. In some examples, the UE 120 may communicate indirectly with the network node 110 via an indirect link 710. For example, a communication may be transmitted via different segments of the indirect link 710. A communication transmitted via the indirect link 710 between the UE 120 and the network node 110 is reflected and/or redirected by the RIS 160. As shown in FIG. 7 and by reference number 715, the network node 110 may communicate with the RIS 160 (e.g., with the RIS controller 610) via a control channel. For example, the network node 110 may indicate, in a RIS control message, spatial direction(s) and/or signal characteristics for signals reflected by the RIS 160. The RIS controller 610 may configure reconfigurable elements of the RIS 160 in accordance with the RIS control message. In some examples, the RIS control message may indicate information associated with the wireless network, such as a frame structure, time synchronization information, and/or slot boundaries, among other examples. Using the communication scheme shown in FIG. 7 may improve network performance and increase reliability by providing the UE 120 with link diversity for communicating with the network node 110.

In some cases, the UE 120 may receive a communication (e.g., the same communication) from the network node 110 via both the direct link 705 and the indirect link 710. In other cases, the network node 110 may select one of the links (e.g., either the direct link 705 or the indirect link 710), and may transmit a communication to the UE 120 using only the selected link. Alternatively, the network node 110 may receive an indication of one of the links (e.g., either the direct link 705 or the indirect link 710) may transmit a communication to the UE 120 using only the indicated link. The indication may be transmitted by the UE 120 and/or the RIS 160. In some examples, such selection and/or indication may be based at least in part on channel conditions and/or link reliability.

As indicated above, FIG. 7 is provided as an example. Other examples may differ from what is described with respect to FIG. 7.

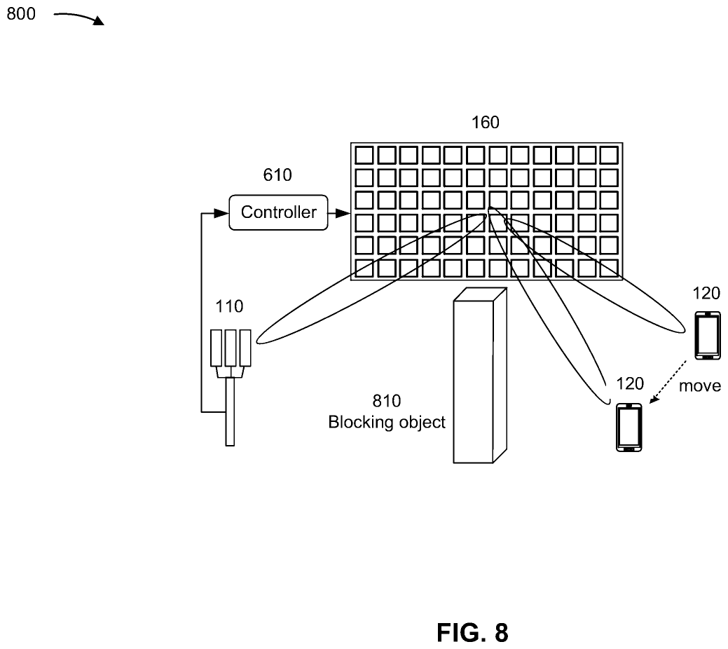

FIG. 8 is a diagram illustrating an example 800 involving a RIS 160, in accordance with the present disclosure. As shown, a blocking object 810 (e.g., a building or other structure) may prevent signals from propagating directly between the network node 110 and UE 120. The RIS 160 may enable the network node 110 and UE 120 to transmit communications around the blocking object, via the RIS 160. For example, the RIS 160 may redirect a transmission from the network node 110 toward the UE 120. As shown, if the UE 120 moves (e.g., changes position), then the RIS 160 may adjust the reconfigurable elements of the RIS 160 accordingly such that the RIS 160 redirect signals to and/or from the new position of the UE 120.

As indicated above, FIG. 8 is provided as an example. Other examples may differ from what is described with respect to FIG. 8.

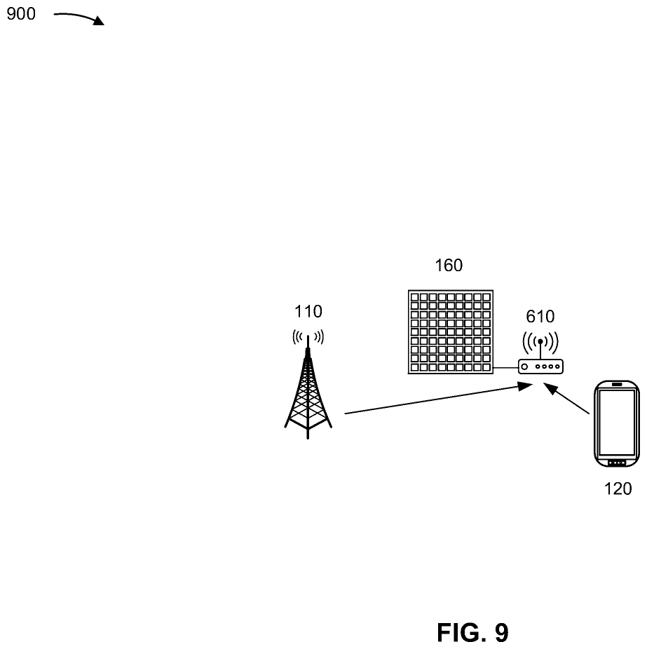

FIG. 9 is a diagram illustrating an example 900 involving a RIS controller 610, in accordance with the present disclosure. As a passive antenna array, the RIS 160 may perform beamforming both in the incident angles and in the reflection angles. The beams of the reflection angle and the incident angle of the RIS 160 may be controlled by reflection coefficients of antenna elements of the RIS 160. The antenna elements of the RIS 160 may be set by the RIS controller 610, which may be active. The RIS controller 610 may be a UE or IAB and may be controlled by the network node 110 or the UE 120.

As indicated above, FIG. 9 is provided as an example. Other examples may differ from what is described with respect to FIG. 9.

A RIS may be a network-controlled RIS or a UE-controlled RIS. A UE-controller RIS may be appropriate if the RIS may be deployed not by operators but instead by a third party or user to improve cellular coverage for a specific scenario (e.g., factory, campus, office park, business district, home, car, or the like). A UE-controlled RIS may be transparent to the network (e.g., the UE may configure and control the RIS via the RIS controller without network authorization) or non-transparent to the network (e.g., the UE may configure and control the RIS via the RIS controller with network authorization).

A UE attempting to control a RIS may face challenges associated with establishing a network connection with a network node when the UE is out-of-coverage from the network node. For example, before the UE takes control of the RIS, the UE may be unable to establish the network connection with the network node. Furthermore, because the UE is out-of-coverage, the UE may be unable to communicate directly with the network node (e.g., to establish the network connection directly with the network node and/or to enable the UE to control the RIS).

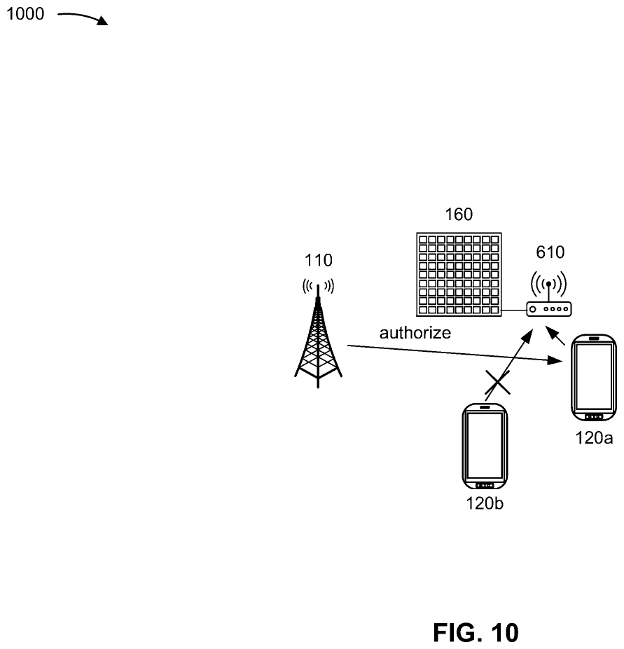

FIG. 10 is a diagram illustrating an example 1000 of a RIS 160 that is non-transparent to a network (e.g., network node 110) and controlled by a UE 120a that is in-coverage with the network node 110, in accordance with the present disclosure. Because the RIS 160 is a UE-controlled RIS that is non-transparent to the network, the UE 120a may obtain authorization from the network (e.g., from network node 110) to control the RIS 160. As shown, the in-coverage UE 120a may obtain the authorization directly from the network node 110 (e.g., instead of via the RIS 160). Upon obtaining the authorization, the UE 120a may control reflection features of the RIS 160. A UE 120b that has not obtained the authorization may not control the RIS 160.

As indicated above, FIG. 10 is provided as an example. Other examples may differ from what is described with respect to FIG. 10.

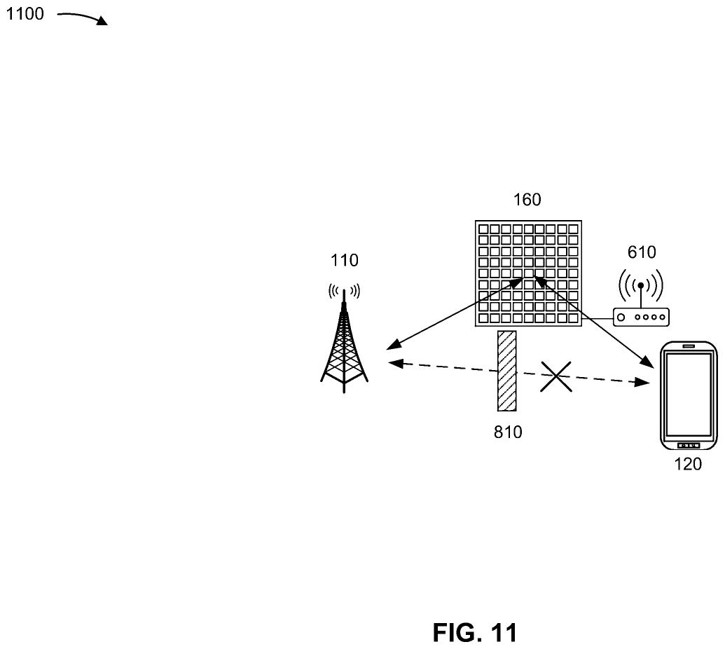

FIG. 11 is a diagram illustrating an example 1100 of a RIS 160 that is non-transparent to a network (e.g., network node 110) and controlled by a UE 120 that is out-of-coverage with the network node 110, in accordance with the present disclosure. As shown, the blocking object 810 may cause the UE 120 to be out-of-coverage from the network node 110. The RIS 160 may be adopted to enlarge the coverage of the network node 110 (e.g., to enable the network node 110 and UE 120 to communicate even though the UE 120 is out-of-coverage). Thus, the network node 110 and the UE 120 communicate via the reflection link of the RIS 160.

In this example, because the RIS 160 is non-transparent to the network, the UE 120 may require authorization from the network node 110 to control the RIS 160.

However, the UE 120 can only reach the network node 110 using the RIS 160 (unlike the in-coverage UE 120a in example 1000). An out-of-coverage UE (e.g., the UE 120) may not have an existing network connection or direct link with a network node to help validate the authorization). Therefore, the out-of-coverage UE may be unable to obtain a network authorization to control a RIS. Furthermore, the RIS may be unable to validate such a network authorization of the out-of-coverage UE, and the network authorization may not be secure.

As indicated above, FIG. 11 is provided as an example. Other examples may differ from what is described with respect to FIG. 11.

FIG. 12 is a diagram illustrating an example 1200 associated with UE control of a RIS 160, in accordance with the present disclosure. As shown in FIG. 12, example 1200 includes communication between a network node 110 and a UE 120. In some aspects, network node 110 and UE 120 may be included in a wireless network, such as wireless network 100. Network node 110 and UE 120 may communicate via a wireless access link, which may include an uplink and a downlink.

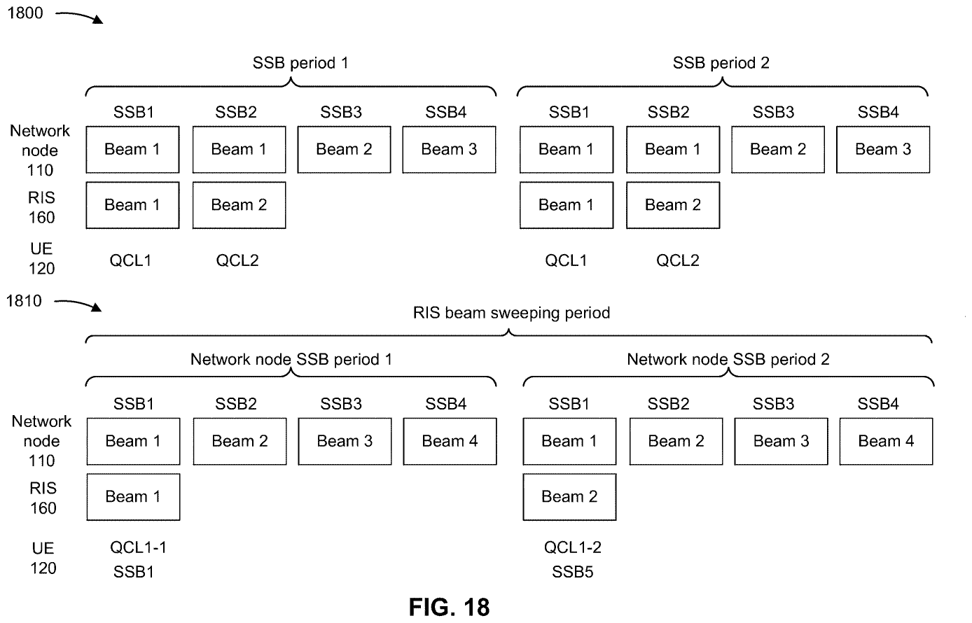

As shown by reference number 1210, the UE 120 may receive an indication of a RIS beam-sweeping period. For example, the UE 120 may receive the indication of the RIS beam-sweeping period from the RIS controller 610. Receiving the indication of the RIS beam-sweeping period may enable the UE 120 to differentiate between RIS beams carrying SSBs associated with the same SSB index. The indication of the RIS beam-sweeping period is discussed in greater detail below with reference to FIG. 18.

As shown by reference number 1220, the network node 110 may output, and the UE 120 may receive, via the RIS 160, an SSB. The UE 120 may receive the SSB over a pair of RIS beams, including a network-side beam and a UE-side beam. The SSB may be associated with an SSB index that is based at least in part on the RIS beam-sweeping period.

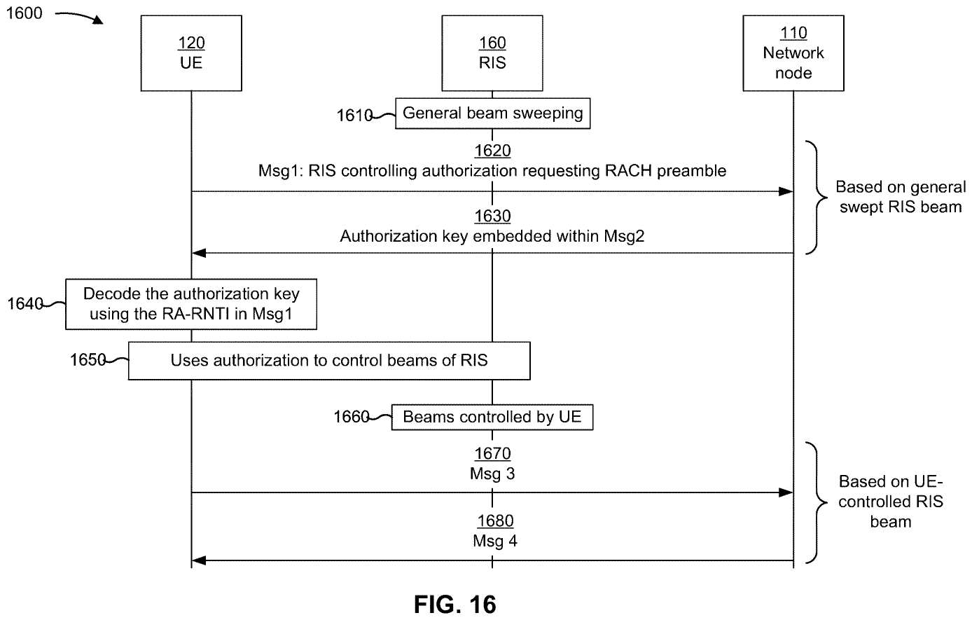

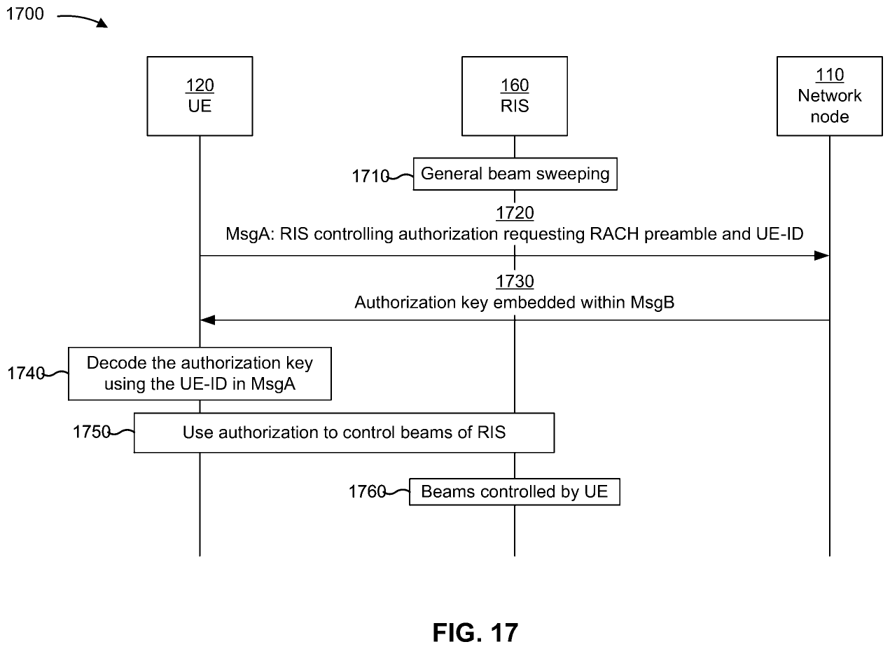

As shown by reference number 1230, the network node 110 may provide an authorization for the UE 120 to control the RIS 160. For example, the network node 110 may output a message of a random access procedure (e.g., a two-step random access procedure or a four-step random access procedure) that includes an authorization for the UE to control the RIS 160. The random access procedure is discussed in greater detail below with reference to FIGS. 16 and 17.

As shown by reference number 1240, the network node 110 and the UE 120 may establish a network connection with each other based at least in part on the SSB. The UE 120 and the network node 110 may establish the network connection by performing a random access procedure via the RIS 160. For example, the random access procedure may include a two-step or four-step random access procedure that is performed based on the SSB. In some examples, the UE 120 may establish the network connection by transmitting a control signal for controlling the RIS 160, which may be configured to be controlled by the UE 120. For example, the RIS controller 610 may receive the control signal and configure the RIS 160 in accordance with the control signal. One or more operations associated with reference number 1240 may occur before, during, and/or after one or more operations associated with reference number 1230.

In a first aspect, the UE 120 may transmit the control signal based at least in part on the authorization to control the RIS 160. For example, in the first aspect, the UE 120 may obtain the authorization while or after performing the random access procedure and may transmit the control signal after obtaining the authorization. In this example, the RIS 160 may be non-transparent to the network (e.g., network node 110). In the first aspect, the first UE of any UE that is to control the RIS 160 (e.g., UE 120) may obtain authorization for any control of the RIS 160. In use cases involving authorization, the RIS 160 may be considered a network service.

The network node 110 and the UE 120 establishing the network connection with each other based at least in part on the SSB (as shown by reference number 1240) may enable the UE 120 to communicate with the network node 110 via the RIS 160 while the UE 120 controls the RIS 160. For example, the network node 110 and the UE 120 may establish the network connection even if the UE 120 is out-of-coverage with the network node 110, thereby enabling an out-of-coverage UE to control a RIS 160 and communicate with the network node 110.

The authorization may enable the network node 110 to centralize management and coordinate control by the UE 120 of the RIS 160. For example, the authorization may enable the network node 110 to avoid collisions when multiple UEs attempt to control the same RIS 160. The authorization may increase safety (e.g., security) and provide every UE with an equal chance to access the network node 110.

As indicated above, FIG. 12 is provided as an example. Other examples may differ from what is described with respect to FIG. 12.

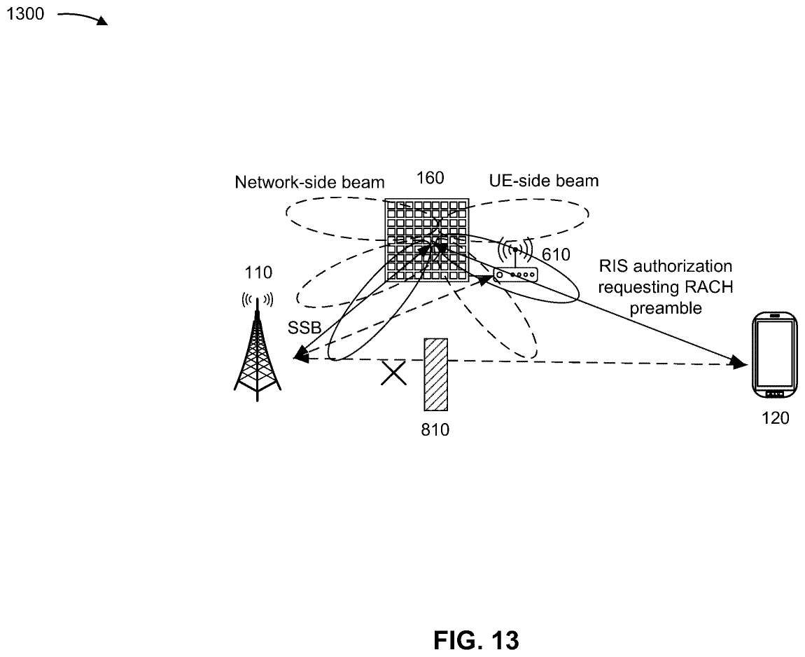

FIGS. 13-17, described in greater detail as follows, may apply to at least the first aspect (e.g., cases where the UE 120 transmits the control signal based at least in part on an authorization to control the RIS 160).

FIG. 13 is a diagram illustrating an example 1300 relating to two-sided beam-sweeping for an out-of-coverage UE (e.g., UE 120), in accordance with the present disclosure. The RIS controller 610 may be a single antenna device that does not have beamforming capabilities. The network-side beam and the UE-side beam may comprise a pair of incidence and reflection beams for the reflection link via the surface of RIS 160.

The RIS 160 may perform general (e.g., two-sided) beam-sweeping. The general beam-sweeping may involve the RIS 160 sweeping network-side beams and UE-side beams, which may enable the UE 120 to access the network node 110. The RIS controller 610 may receive an SSB via a receiver of the RIS controller 610 and the UE 120 may receive the SSB via the network-side (incident) beam and the UE-side (reflection) beam of the RIS 160. Thus, the RIS controller 610 may not determine which network-side beam is pointing toward the network node 110 until a first UE (e.g., the UE 120) to attempt to establish a network connection with the network node 110 via the RIS 160 receives an SSB via RIS reflection and indicates, to the RIS controller 610, that the UE 120 has received the SSB.

Therefore, the two-side beam sweeping may be used for the first UE. After the first UE locates the appropriate network-side beam of RIS, the network-side beam may be fixed, and only UE-side beam sweeping may be used for subsequent UEs. Moving or blocking the RIS 160 with respect to the network node 110 may cause link failure, which may trigger further two-sided beam-sweeping.

The UE 120, which is out-of-coverage and/or RRC IDLE, and which is unauthorized to control the RIS 160, may transmit a request for authorization to control the RIS 160. In some examples, the UE 120 may transmit the request via a random access (e.g., RACH or PRACH) procedure (as part of a RACH preamble). The RIS 160 may reflect the request to the network node 110 based on general beam-sweeping of the RIS 160.

As indicated above, FIG. 13 is provided as an example. Other examples may differ from what is described with respect to FIG. 13.

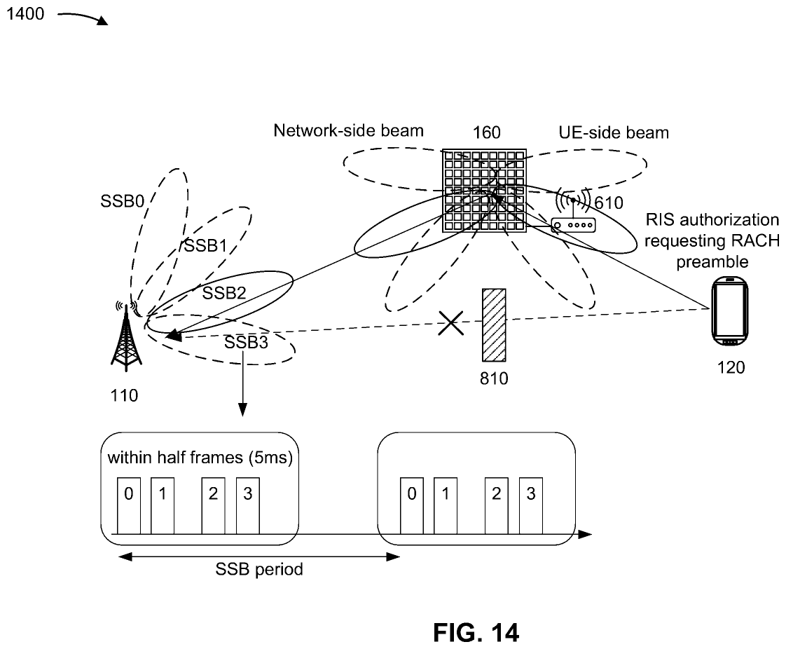

Aspects described in relation to FIG. 13 above are described in greater detail below with reference to FIGS. 14-17.

FIG. 14 is a diagram illustrating an example 1400 of timing associated with two-sided beam-sweeping for an out-of-coverage UE (e.g., UE 120), in accordance with the present disclosure.

In some examples, the SSB may be transmitted between the network node 110 and the UE 120 over a pair of RIS beams, including a network-side beam and a UE-side beam. The RIS controller 610 may hold (e.g., pause) the pair of RIS beams for a time interval that is greater than or equal to an SSB period. As shown, an SSB period may include at least an amount of time involved for the network node 110 to cycle through a plurality of network transmit beams (e.g., beams over which the network node 110 outputs SSBs).

For example, during the two-sided beam-sweeping, the RIS 160 (and/or the RIS controller 610) may hold each pair of RIS beams (e.g., each pair of a network-side beam and a UE-side beam) for at least an SSB period. The RIS controller 610 may determine the SSB period (e.g., 20 ms) from a SIB that the RIS controller 610 receives from the network node 110 and decodes. Based on the SSB period, the RIS controller 610 may synchronize to the network node 110 and hold a pair of RIS beams for at least an SSB period.

In some examples, the period of RIS general beam-sweeping may be NM×SSB_Period, where N is a quantity of network-side beams, M is a quantity of UE-side beams, and SSB_Period is the SSB period. In some examples, the RIS controller 610 may hold the RIS beam pair for longer than the SSB period. For example, the RIS controller 610 may hold the RIS beam pair for SSB period+T, where T is an amount of time that may enable the UE to, after receiving the SSB, send the RACH preamble and receive an authorization key (e.g., a msg2) from the network node 110.

Because the network-side and UE-side beams are designed for signal reflection and may not receive from or transmit to the RIS controller 610, the RIS controller 610 may not directly determine which RIS beam pair (e.g., which combination of network-side beam and UE-side beam) is suitable for UE 120 (e.g., which RIS beam pair the UE 120 can receive an SSB over). Thus, receiving the SSB over the pair of RIS beams held for a time interval that is greater than or equal to an SSB period may help to ensure that each pair of RIS beam reflect the SSB from the network node 110 to the UE 120 and establish a network connection using the pair of RIS beams.

As indicated above, FIG. 14 is provided as an example. Other examples may differ from what is described with respect to FIG. 14.

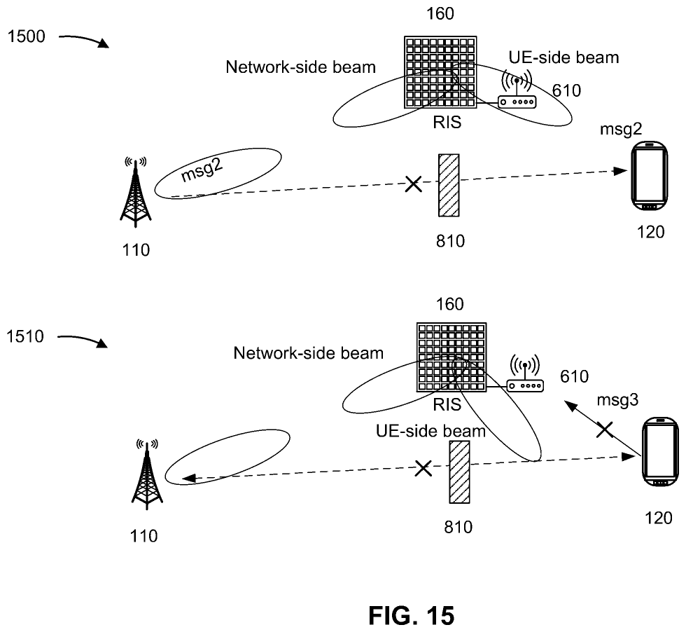

FIG. 15 is a diagram illustrating examples 1500 and 1510 of a timing issue related to two-sided beam-sweeping involving a RACH procedure, in accordance with the present disclosure.

As shown by example 1500, at a first time, the UE 120 may successfully receive the SSB when the network-side beam of the RIS 160 is directed toward the network node 110 and the UE-side beam is directed toward the UE 120. The network node 110 may identify which of the network transmit beams are directed toward the RIS 160 based on feedback obtained from the RIS controller 610 after the RIS controller 610 receives the SSB. The UE 120 may receive a msg2 from the network node 110, which may prompt the UE 120 to transmit a msg3 to the network node 110.

As shown by example 1510, before the UE 120 transmits the msg3, the RIS 160 changes the UE-side beam and, thus, no longer holds the RIS beam pair. As a result, the UE 120 may not complete the random access procedure (e.g., by transmitting msg3 and receiving msg4). Instead, the UE 120 may wait for the RIS general beam-sweeping period, after which the physical link between the UE 120 and the network node 110 may be re-established.

Because the two-side beams of the RIS 160 may change between any step of the RACH procedure, attempting to access (e.g., obtain control of) the RIS 160 using a four-step RACH procedure based on general beam-sweeping of RIS without obtaining authorization to control the RIS 160 may involve waiting times, such as delays equal to at least the RIS general beam-sweeping period. For example, the UE 120 may wait for a RIS beam-sweeping period for the next RACH step in the RACH procedure, or the RACH procedure may fail due to a timeout.

As indicated above, FIG. 15 is provided as an example. Other examples may differ from what is described with respect to FIG. 15.

In some aspects, performing the random access procedure (as shown by reference number 1240) may include transmitting, by the UE 120, and obtaining, by the network node 110, a first message of the random access procedure requesting the authorization to control the RIS. Performing the random access procedure may further include outputting, by the network node 110, and receiving, by the UE 120, a second message of the random access procedure that includes an authorization key that provides the authorization to control the RIS.

Transmitting, by the UE 120, and obtaining, by the network node 110, a first message of the random access procedure requesting the authorization to control the RIS, and outputting, by the network node 110, and receiving, by the UE 120, a second message of the random access procedure that includes an authorization key that provides the authorization to control the RIS may reduce signaling and/or time associated with successfully completing the random access procedure. For example, combining the random access procedure with a RIS control authorization procedure (during which the UE 120 requests authorization to control the RIS 160) may reduce delays associated with waiting for a RIS general beam-sweeping period. As a result, the network node 110 may authorize the UE 120 to control the RIS 160 based on a combined procedure involving RACH, which may improve the time efficiency and reduce signaling associated with the UE 120 (e.g., an out-of-coverage UE) obtaining network access using the RIS 160.

In some examples, the random access procedure may be a four-step random access procedure and, the first message may be a msg1, and the second message may be a msg2. In some examples, the random access procedure may be a two-step random access procedure and, the first message may be a msgA, and the second message may be a msgB. FIG. 16 illustrates an example involving a four-step random access procedure, and FIG. 17 illustrates an example involving a two-step random access procedure.

FIG. 16 is a diagram illustrating an example 1600 of a four-step random access procedure that integrates a RIS control authorization procedure, in accordance with the present disclosure.

As shown by reference number 1610, the RIS 160 may perform general beam-sweeping. In an unknown direction state of network node 110, the RIS 160 may sweep both network-side beams and UE-side beams, as described above in connection with FIG. 13. In a known direction state of network node 110, the RIS 160 may hold the network-side beam and perform UE-side beam-sweeping. During the beam-sweeping, the UE 120 may receive an SSB. A configured time period may provide sufficient time for the UE 120 to receive the SSB in view of the time involved in beam-sweeping performed by the network node 110 and beam-sweeping performed by the RIS 160 (e.g., RIS two-sided beam-sweeping).

As shown by reference number 1620, the UE 120 may transmit, and the network node 110 may obtain, a first message (msg1) of the four-step random access procedure. The first message may request the authorization to control the RIS 160. The first message may include a RACH preamble that is associated with a request for authorization to control the RIS 160. The UE 120 may transmit the first message, after receiving the SSB (e.g., a beamformed SSB) via RIS reflection, at a PRACH channel corresponding to the SSB.

In some examples, the first message is associated with a random access radio network temporary identifier (RA-RNTI) that is associated with requesting the authorization to control the RIS 160. For instance, the RA-RNTI may be determined based on the PRACH in which the RACH preamble is transmitted. The RA-RNTI may be one of a plurality (e.g., a subset) of RA-RNTIs associated with requesting the authorization to control the RIS 160. The network node 110 may recognize that the first message is associated with a request for authorization to control the RIS 160 based on the RA-RNTI.

In some examples, the first message is associated with a random access channel (e.g., a PRACH) that is associated with requesting the authorization to control the RIS 160. For instance, the UE 120 may transmit the RACH preamble in the PRACH. The PRACH may be one of a plurality (e.g., a subset) of PRACHs associated with requesting the authorization to control the RIS 160. The network node 110 may recognize that the first message is associated with a request for authorization to control the RIS 160 based on the random access channel.

As shown by reference number 1630, the network node 110 may output, and the UE 120 may receive, a second message (msg2) of the four-step random access procedure. The second message may include an authorization key that provides the authorization to control the RIS 160. For example, network node 110 may output the second message with the authorization key embedded therein, and the UE 120 may receive the second message via RIS reflection. In some examples, the authorization key may be encoded or scrambled with the RA-RNTI discussed above.

In some examples, the network node may output, and the RIS controller 610 may receive, an indication of another authorization key. The other authorization key may be paired to the authorization key included in the second message. The RIS controller 610 may use the other authorization key to validate the authorization of the UE 120.

Network node 110 may broadcast the second message, which may allow other UEs using the same RA-RNTI as the UE 120 uses to receive the second message (e.g., to receive the authorization key). When another UE using that RA-RNTI receives the second message, then that UE may obtain authorization to control the RIS 160 instead of the UE 120. If the other UE is out-of-coverage, then the other UE may use the same UE-side beam of the RIS 160. Thus, regardless of whether the UE 120 or the other UE controls the RIS 160, the UE 120 may establish a network connection with the network node 110. For example, the UE 120 may share the UE-side beam with the other UE that controls the RIS 160.

If the other UE is in-coverage, then that UE would, if allowed to obtain authorization to control the RIS 160, use a different UE-side beam than the UE 120, which is out-of-coverage and therefore in a different location than the other UE. In some examples, the RIS controller 610 may enforce a validation condition that prevents the other, in-coverage UE from obtaining authorization to control the RIS 160. The validation condition may allow access based on the UE that has received the authorization key indicating the UE-side beam that was used by the RIS 160 at a certain time. Thus, if the UE-indicated UE-side beam is not the UE-side beam that was used by the RIS 160 at that time, then the RIS 160 may consider the UE that indicated the UE-side beam (e.g., the in-coverage UE) to be unauthorized despite having received the authorization key.

As shown by reference number 1640, the UE 120 may decode the authorization key using the RA-RNTI in msg1 and thereby obtain authorization to control the RIS 160. As shown by reference number 1650, the UE 120 may use the authorization to control the RIS 160. For example, the UE 120 may transmit, and the RIS controller 610 may receive, the control signal. The control signal may be an indication for the RIS 160 to hold a pair of RIS beams, including a network-side beam and a UE-side beam. For example, the network-side beam and the UE-side beam may be the combination of beams over which the UE 120 received the SSB. The UE 120 may transmit the control signal based at least in part on the authorization key. For example, the control signal may be scrambled or cyphered using the authorization key or may include the authorization key. Holding the pair of RIS beams may enable the network node 110 and UE 120 to complete the four-step random access procedure before the RIS beams change.

As shown by reference 1660, the RIS beams are controlled by the UE 120. For example, the RIS 160 may hold the pair of RIS beams in response to the control signal. In some examples, the UE 120 may control the RIS 160 to stop (e.g., pause) beam-sweeping. The RIS controller 610 may stop the RIS 160 from beam-sweeping in one resource and permit the RIS 160 to continue beam-sweeping in other resources, which may enable other UEs to receive an SSB and/or perform a PRACH procedure via the RIS 160. The resources may be time slots or portions of the surface of the RIS 160.

In some examples, the UE 120 may control the RIS 160 to use the two-side beams that were used a time t ago. The time t may be related to the time involved for the RIS 160 to validate the authorization of the UE 120. For example, the time t may correspond to the current SSB or the previous n-th SSB.

After the UE has obtained control of the RIS beams, network node 110 and UE 120 may complete the RACH procedure using the RIS beams controlled by UE. For example, the network node 110 and UE 120 may complete the RACH procedure without waiting for the RIS general beam-sweeping.

As shown by reference 1670, the UE 120 may transmit, and the network node 110 may obtain, based at least in part on the UE 120 transmitting the control signal, a third message (msg3) of the four-step random access procedure. The UE 120 may transmit, and the network node 110 may obtain, the third message via RIS reflection. In some examples, the UE 120 may receive the fourth message of the random access procedure within a configured timeout window. For example, the configured timeout window may persist between msg2 and msg3. The configured timeout window may be extended, which may provide additional time for signaling associated with the RIS 160 validating the authorization request of the UE 120 and signaling associated with the UE 120 controlling the RIS 160.

As shown by reference 1680, the network node may output, and the UE 120 may receive, a fourth message (msg4) of the four-step random access procedure. The UE 120 may transmit, and the network node 110 may obtain, the fourth message via RIS reflection.

Example 1600 may include a combined RIS-control authorization and RACH procedure that provides the UE 120 authorization to control the RIS 160 and access to the network node 110. Example 1600 may reduce signaling and time involved in the UE 120 establishing a network connection with the network node 110 using the four-step random access procedure.

As indicated above, FIG. 16 is provided as an example. Other examples may differ from what is described with respect to FIG. 16.

FIG. 17 is a diagram illustrating an example 1700 of a two-step random access procedure that integrates a RIS control authorization procedure, in accordance with the present disclosure.

As shown by reference number 1710, the RIS 160 may perform general beam-sweeping. In an unknown direction state of network node 110, the RIS 160 may sweep both network-side beams and UE-side beams, as described above in connection with FIG. 13. In a known direction state of network node 110, the RIS 160 may hold the network-side beam and perform UE-side beam-sweeping. During the beam-sweeping, the UE 120 may receive an SSB. A configured time period may provide sufficient time for the UE 120 to receive the SSB in view of the time involved in beam-sweeping performed by the network node 110 and beam-sweeping performed by the RIS 160 (e.g., RIS two-sided beam-sweeping).

As shown by reference number 1720, the UE 120 may transmit, and the network node 110 may obtain, a first message (msgA) of the two-step random access procedure. The first message may request the authorization to control the RIS 160. The first message may comprise a RACH preamble that is associated with a request for authorization to control the RIS 160. The first message may include a UE identifier (“UE-ID”), which may resolve competition between the UE 120 and one or more other UEs. The UE 120 may transmit the first message, after receiving the SSB (e.g., a beamformed SSB) via RIS reflection, at a PRACH channel corresponding to the SSB.

In some examples, the first message is associated with an RA-RNTI that is associated with requesting the authorization to control the RIS 160. For instance, the RA-RNTI may be determined based on the PRACH in which the RACH preamble is transmitted. The RA-RNTI may be one of a plurality (e.g., a subset) of RA-RNTIs associated with requesting the authorization to control the RIS 160. The network node 110 may recognize that the first message is associated with a request for authorization to control the RIS 160 based on the RA-RNTI.

In some examples, the first message is associated with a random access channel (e.g., a PRACH) that is associated with requesting the authorization to control the RIS 160. For instance, the UE 120 may transmit the RACH preamble in the PRACH. The PRACH may be one of a plurality (e.g., a subset) of PRACHs associated with requesting the authorization to control the RIS 160. The network node 110 may recognize that the first message is associated with a request for authorization to control the RIS 160 based on the random access channel.

As shown by reference number 1730, the network node 110 may output, and the UE 120 may receive, a second message (msg2) of the four-step random access procedure. The second message may include an authorization key that provides the authorization to control the RIS 160. For example, network node 110 may output the second message with the authorization key embedded therein, and the UE 120 may receive the second message via RIS reflection. In some examples, the network node 110 may encode or scramble the authorization key with the UE-ID, which may prevent other UEs from obtaining the authorization key.

In some examples, the network node may output, and the RIS controller 610 may receive, an indication of another authorization key. The other authorization key may be paired to the authorization key included in the second message. The RIS controller 610 may use the other authorization key to validate the authorization of the UE 120.

As shown by reference number 1740, the UE 120 may decode the authorization key using the RA-RNTI in msgA and thereby obtain authorization to control the RIS 160. As shown by reference number 1750, the UE 120 may use the authorization to control the RIS 160. For example, the UE 120 may transmit, and the RIS controller 610 may receive, the control signal. The control signal may be an indication for the RIS 160 to hold a pair of RIS beams, including a network-side beam and a UE-side beam. For example, the network-side beam and the UE-side beam may be the combination of beams over which the UE 120 received the SSB. The UE 120 may transmit the control signal based at least in part on the authorization key. For example, the control signal may be scrambled or cyphered using the authorization key or may include the authorization key. Holding the pair of RIS beams may enable the network node 110 and UE 120 to complete the two-step random access procedure before the RIS beams change.

As shown by reference 1760, the RIS beams are controlled by the UE 120. For example, the RIS 160 may hold the pair of RIS beams in response to the control signal. In some examples, the UE 120 may control the RIS 160 to stop (e.g., pause) beam-sweeping. The RIS controller 610 may stop the RIS 160 from beam-sweeping in one resource and permit the RIS 160 to continue beam-sweeping in other resources, which may enable other UEs to receive an SSB and/or perform a PRACH procedure via the RIS 160. The resources may be time slots or portions of the surface of the RIS 160.

As indicated above, FIG. 17 is provided as an example. Other examples may differ from what is described with respect to FIG. 17.

In some examples, the RIS 160 may be configured to perform a beam-sweeping procedure based at least in part on whether a RIS controller (e.g., RIS controller 610) associated with the RIS 160 has received an indication of a direction of the network node 110. As noted above, RIS 160 may perform general beam-sweeping, which may help unauthorized UEs obtain authorization to control the RIS 160. The RIS 160 may operate in two states: an unknown direction state for network node 110 or a known direction state for network node 110.

The RIS 160 may operate in the unknown direction state when the RIS controller 610 has not received an indication of the direction of the network node 110 and therefore the direction of the network node 110 is unknown to RIS controller 610. In the unknown direction state, the RIS 160 may perform two-sided beam-sweeping.

The RIS 160 may operate in the known direction state when the RIS controller 610 has received an indication of the direction of the network node 110 and therefore the direction of the network node 110 is known to RIS controller 610. In the known direction state, the RIS 160 may perform UE-side beam-sweeping with a fixed network-side beam pointing in the direction of the network node 110.

In some examples, the RIS controller 610 may determine the direction of the network node 110 based on receiving a position (e.g., direction) of the network node 110 from the network node 110. In some examples, the RIS controller 610 may determine the direction of the network node 110 based on a previous RIS beam-sweeping operation. For instance, a first UE (e.g., a UE that attempted to obtain authorization to control the RIS 160 before the UE 120) may have previously used the RIS general beam-sweeping to search for the direction of the network node 110. For example, the first UE may determine the direction of the network node 110 with respect to the RIS 160 based on the network-side beam over which the first UE can receive the SSB or system information from the network node 110. Thus, during operations associated with the first UE, the direction state may change from unknown to known. For subsequent UEs (e.g., UE 120), the RIS 160 may operate in a known direction state with respect to network node 110.

Performing the beam-sweeping procedure based at least in part on whether the RIS controller 610 has received the indication of the direction of the network node 110 may help to ensure that the network node 110 and the UE 120 can establish a network connection via the RIS 160 without expending unnecessary resources. For example, if the RIS controller 610 has not received the indication of the direction of the network node 110 (e.g., if the RIS 160 is operating in the unknown direction state), then the RIS 160 may perform general two-sided beam-sweeping, which may enable the RIS controller 610 to determine the direction of the network node 110. If the RIS controller 610 has received the indication of the direction of the network node 110 (e.g., if the RIS 160 is operating in the known direction state), then the RIS 160 may perform UE-sided beam-sweeping (e.g., and avoid sweeping over network-side beams), which may reduce resources (e.g., power) associated with the beam-sweeping operation.

The authorization to control the RIS 160 may expire. In some examples, the authorization to control the RIS 160 may expire based on a threshold time period associated with the authorization to control the RIS 160. For instance, the authorization may be associated with a maximum time limitation. In some examples, the authorization to control the RIS 160 may expire based on a threshold amount of traffic associated with the authorization to control the RIS 160. For instance, the authorization may be associated with a maximum traffic amount limitation. In some examples, the authorization to control the RIS 160 may expire based on a priority associated with the UE 120. For instance, if a higher-priority UE requests the authorization, the authorization of the UE 120 (which may be associated with a lower priority) expires. Priority assignment may be fee-based. The authorization expiring may enable other UEs to control the RIS 160 and thereby access network node 110.

In some examples, the network node 110 may output, and the UE 120 may receive, an indication that the authorization to control the RIS 160 has expired. For example, based on the authorization of the UE 120 expiring, the network node 110 may indicate, to the UE 120, the release of the authorization of the UE 120. In some examples, the UE 120 may transmit, and the network node 110 may obtain, a request to release the authorization to control the RIS. For example, based on the UE 120 no longer using the RIS 160, the UE 120 may request, to the network node 110, that the network node 110 release the authorization of the UE 120.

Additionally, or alternatively, the network node 110 may indicate, to the RIS controller 610, that the authorization of the UE 120 has been released. For example, the network node 110 may output one or more of the authorization key or the UE-ID. In some cases, the RIS controller 610 may identify the UE 120 based on the authorization key (e.g., without the UE-ID) when the control signal obtained from the UE 120 is scrambled or cyphered using the authorization key or includes the authorization key. After obtaining the indication that the authorization of the UE 120 has been released, the RIS controller 610 may not operate based on any control signaling from the UE 120.

As noted, in the first aspect, the UE 120 transmits the control signal based at least in part on an authorization to control the RIS 160. Several other aspects are provided herein. In a second aspect, a UE (e.g., UE 120) that is to control the RIS 160 may not obtain an authorization for any control of the RIS 160. For example, the UE 120 may transmit the control signal before or while performing the random access procedure. For example, the UE 120 may cause (e.g., using the control signal) the RIS 160 to sweep two beams (e.g., one UE-side beam and one network-side beam) to locate the network node. In some examples, if the UE 120 receives an SSB and other system information from the network node, then the current two beams of the RIS 160 provide communication between the network node 110 and the UE 120. In some examples, the UE 120 may send an indication of the position of the UE 120 to the RIS controller 610, which may enable the RIS 160 to fix the UE-side beam toward the UE 120 and sweep only the network-side beam. In some examples, signaling may be provided between the RIS controller 610 and the UE 120 to indicate whether the UE 120 is the first UE that is to control the RIS 160.

In a third aspect, a UE (e.g., UE 120) that is to control the RIS 160 may not obtain an authorization to temporarily stop the RIS 160 from performing beam-sweeping, and the UE 120 may obtain authorization for further control of the RIS 160. For example, the UE 120 may transmit the control signal before or while performing the random access procedure. For example, upon receiving an SSB or system information from the network node 110, the UE 120 may signal the RIS 160 to temporarily stop beam-sweeping. If the RIS 160 changes beams after the UE 120 receives the SSB (e.g., and before the UE 120 completes a random access procedure), the UE 120 may prompt the RIS controller 610 to use the beam pair used a time t previously. In some examples, t=d/c, where c is the speed of light and d is the distance between the UE 120 and the RIS 160. In some examples, d may be determined by the RIS 160 (and/or the RIS controller 610) if the UE 120 indicates a position of the UE 120 to the RIS controller 610. In some examples, signaling may be provided between the RIS controller 610 and the UE 120 to indicate whether the UE 120 is the first UE that is to control the RIS 160. The third aspect may provide every UE with an equal (or near-equal) chance to access the network node 110.

FIGS. 18-20, described in greater detail as follows, may apply to at least one or more of the first aspect, the second aspect, or the third aspect.

FIG. 18 is a diagram illustrating examples 1800 and 1810 that avoid quasi-colocation (QCL) of SSBs, in accordance with the present disclosure. SSBs may be quasi-colocated (from the perspective of the UE 120) when the SSBs are associated with the same SSB index and reflected over different RIS beams.

In example 1800, the RIS 160 is controlled by the network node 110. As shown, the network node outputs an SSB associated with a first SSB index (“SSB1”) over a first network transmit beam (“Beam 1”). SSB1 is transmitted via RIS beam 1 and obtained by the UE 120. The network node further outputs an SSB associated with a second SSB index (“SSB2”) over the first network transmit beam (“Beam 1”). SSB2 is transmitted via RIS beam 2 and obtained by the UE 120. SSB1 and SSB2 are not quasi-colocated because SSB1 and SSB2 are associated with different SSB indexes and the UE 120 receives SSB1 and SSB2 over different beams.

Even though the network node 110 outputs SSB1 and SSB2 over the same network transmit beam, the network node 110 may use different SSB indexes for SSB1 and SSB2. Using different SSB indexes for SSB1 and SSB2 may prevent the UE 120 from determining that SSB1 and SSB2 are quasi-colocated. The network node 110 may determine to use different SSB indexes for SSB1 and SSB2 based on the RIS 160 (which the network node 110 controls) transmitting the SSB1 and SSB2 over different RIS beams.

The network node 110 may further output an SSB associated with a third SSB index (“SSB3”) over a second network transmit beam (“Beam 2”). The network node 110 may further output an SSB associated with a fourth SSB index (“SSB4”) over a third network transmit beam (“Beam 3”). The network node may repeat outputting of SSB1, SSB2, SSB3, and SSB4 over multiple SSB periods (e.g., “SSB period 1,” “SSB period 2,” etc.).

When the RIS 160 is not controlled by the network node 110 (e.g., when the RIS 160 is controlled by the UE 120), the network node 110 may not control the RIS 160, and thus, may not obtain information regarding which RIS beam the RIS 160 is using at a given time. Therefore, when the RIS 160 is controlled by the UE 120, the network node 110 may be unable to prevent QCL of SSBs.

In example 1810, the RIS 160 is controlled by the UE 120, which may be attempting to access a cell (e.g., network node 110) via the RIS 160. Initially, the RIS controller 610 may broadcast information including an indication of the existence of the RIS 160 over a sidelink. If RIS controller 610 is a UE, then the RIS controller 610 may use preserved resources in the sidelink to broadcast the information. If the RIS controller 610 is an IAB, then the RIS controller 610 may broadcast the information via system information. Additionally, or alternatively, the RIS 160 may unicast the information to a UE (e.g., UE 120) that transmits a request for the information.

The information may further include an explicit indication of a RIS beam-sweeping period (e.g., an SSB period). The explicit indication may involve no calculations to determine RIS beam-sweeping period. Additionally, or alternatively, the information may include an implicit indication of the RIS beam-sweeping period. The implicit indication may include factors that may be used to calculate the RIS beam-sweeping period (e.g., the quantity of RIS beams, the duration of each RIS beam, the SSB period of the network node 110, the start time position, or the like).

A first UE that cannot receive the SSB directly from the network node 110 (e.g., an out-of-coverage UE, such as UE 120) may monitor the sidelink and receive the RIS broadcast. For example, the UE 120 may receive an indication of the RIS beam-sweeping period. For example, the UE 120 may receive an explicit indication of the RIS beam-sweeping period and/or an implicit indication of the RIS beam-sweeping period. For example, the UE 120 may calculate the RIS beam-sweeping period by multiplying the quantity of RIS beams by the SSB period of the network node 110.

In some examples, the UE 120 may request the RIS 160 to perform beam-sweeping. In some examples, the RIS 160 may continuously perform the beam-sweeping. As shown, the network node outputs SSBs associated with respective SSB index (“SSB1,” “SSB2,” “SSB3,” “SSB4”) over respective network transmit beams (“Beam 1,” “Beam 2,” “Beam 3,” “Beam 4”). The RIS 160 may read SSB1-SSB4 from the network node 110 and select an SSB index.

The SSB received by the UE 120 may be associated with an SSB index that is based at least in part on the RIS beam-sweeping period. For example, the UE 120 may monitor for the SSB based on the RIS beam-sweeping period. The UE 120 may consider SSBs associated with the same SSB index based on the SSB period of the network node 110 in one RIS beam-sweeping period as being associated with different SSB indexes based on the RIS beam-sweeping period. For example, if the network node outputs “SSB1” in the first RIS beam-sweeping period and the second RIS beam-sweeping period, then the UE 120 may receive a first SSB associated with a first SSB index (“SSB1”) over RIS beam 1 and another SSB associated with another SSB index (“SSB5”) over RIS beam 2 based on the RIS beam-sweeping period. As a result, SSB1 and SSB5 are not quasi-colocated. Any SSBs associated with the same index based on the RIS beam-sweeping period may be quasi-colocated.

The UE 120 receiving the indication of the RIS beam-sweeping period may enable the UE 120 to differentiate between RIS beams carrying SSBs associated with the same SSB index. Associating the SSB received by the UE 120 with an SSB index that is based at least in part on the RIS beam-sweeping period may prevent QCL of the SSBs when the RIS 160 is controlled by the UE 120.

As indicated above, FIG. 18 is provided as an example. Other examples may differ from what is described with respect to FIG. 18.

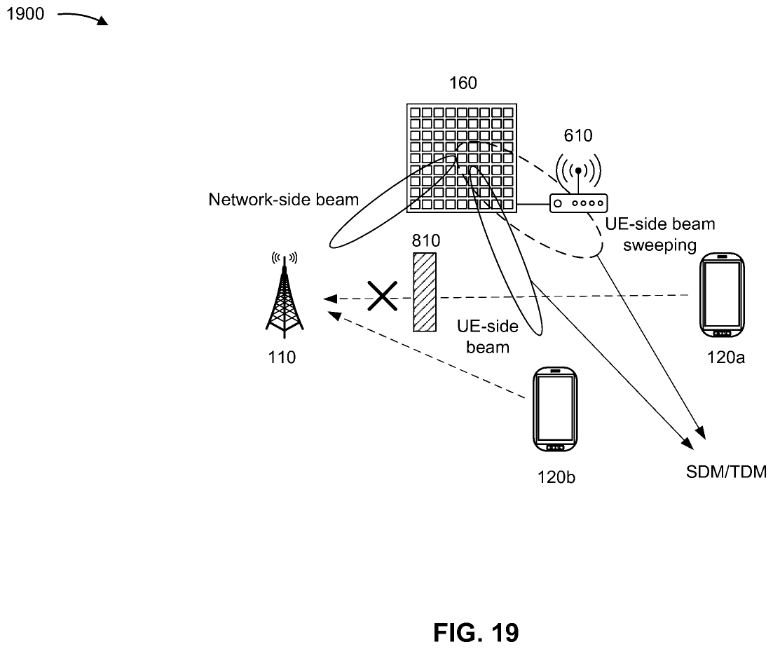

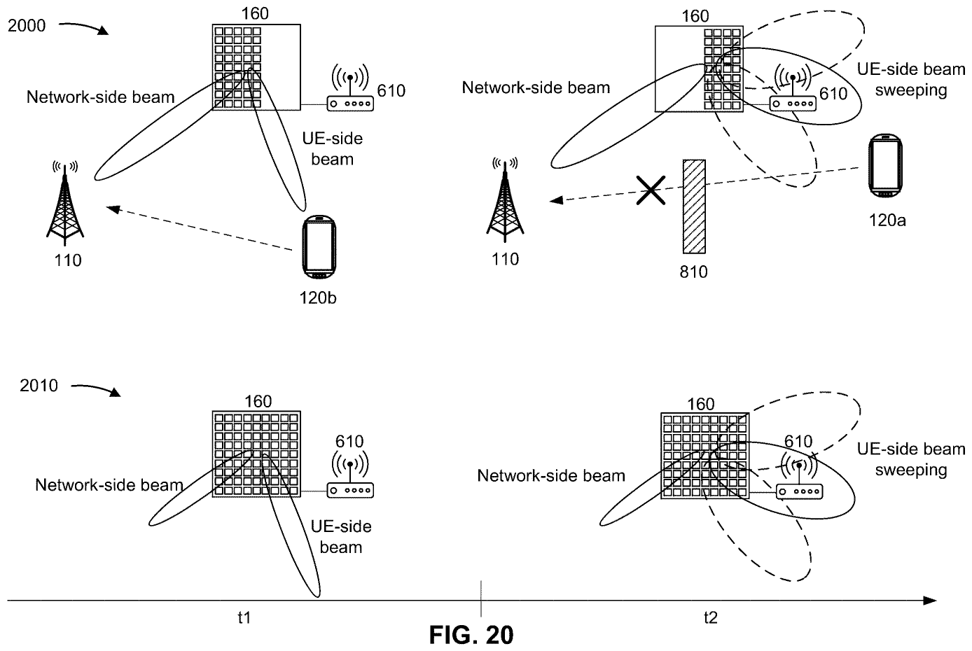

FIG. 19 is a diagram illustrating an example 1900 of multi-UE support for the RIS 160, in accordance with the present disclosure. In example 1900, the RIS 160 may be configured to be controlled by a plurality of UEs. As shown, while the RIS 160 is controlled by a UE (e.g., an authorized UE, such as UE 120b), the RIS 160 may perform UE-side beam-sweeping for out-of-coverage UEs (e.g., an unauthorized UE, such as UE 120a). The RIS 160 may perform the UE-side beam-sweeping based on space division multiplexing (SDM) and/or time division multiplexing (TDM), as discussed in greater detail below in connection with FIG. 20. The RIS 160 being configured to be controlled by a plurality of UEs may enable multiple UEs to control the RIS 160, thereby reducing time associated with the UEs establishing a network connection with network node 110.

As indicated above, FIG. 19 is provided as an example. Other examples may differ from what is described with respect to FIG. 19.

FIG. 20 is a diagram illustrating an example 2000 of multi-UE support for the RIS 160 using SDM and an example 2010 of multi-UE support for the RIS 160 using TDM, in accordance with the present disclosure.

In some examples, the RIS 160 may serve a UE using at least one first resource and perform a UE-side beam-sweeping procedure using at least one second resource. For SDM, if NUEs are controlling the RIS 160, then the RIS 160 may split antenna elements of the RIS 160 to N+1 parts. The N parts are controlled by respective ones of the NUEs. The remaining part may operate UE-side beam-sweeping for potential unauthorized out-of-coverage UE. The RIS 160 may refrain from performing network-side beam-sweeping because the direction of the network node 110 may be known after the first UE obtains control of the RIS 160. In some examples, one or more of the N+1 parts may be multiplexed using SDM and frequency division multiplexing (FDM). Thus, in the case of SDM, the first resource and/or second resources may be SDM and/or FDM resources. The RIS 160 serving the UE using at least one first resource and performing the UE-side beam-sweeping procedure using at least one second resource may enable the RIS 160 to avoid interference or collisions between multiple UEs.

Example 2000 illustrates a scenario where N=1. In example 2000, the UE 120b may be in-coverage or out-of-coverage. The UE 120b may have control of the RIS 160. In some examples, UE 120b may be an authorized UE. UE 120a may be an out-of-coverage UE. In some examples, UE 120a may be an unauthorized UE. As shown, the RIS 160 allocates half of the antenna elements for the UE 120b and half of the antenna elements for UE-side beam-sweeping for UEs such as UE 120a.

In some examples, the UE 120b (e.g., the UE 120 controlling the RIS 160) may transmit, and the network node 110 may obtain, an indication of a target SDM state of the RIS 160. For example, the target SDM state may indicate how SDM resources (and/or FDM resources) of the RIS 160 are and/or will be multiplexed. Transmitting and obtaining the indication of a target SDM state of the RIS 160 may enable the network node 110 to allocate FDM resources for each UE (e.g., for UEs 120a and 120b).

As noted above, in some examples, the RIS 160 may serve a UE using at least one first resource and perform a UE-side beam-sweeping procedure using at least one second resource. For TDM, the RIS 160 may define N+1 time slots as a period. In the N slots, the RIS 160 may be controlled by respective ones of the NUEs. In the remaining slot, the RIS 160 may perform UE-side beam-sweeping for potential unauthorized out-of-coverage UEs. Example 2010 illustrates a scenario where N=1.

Thus, in the case of TDM, the first resource and/or second resources may be TDM resources. The RIS 160 serving the UE using at least one first resource and performing the UE-side beam-sweeping procedure using at least one second resource may enable the RIS 160 to avoid interference or collisions between multiple UEs.

In some examples, a (e.g., UE 120b) may transmit, and the network node 110 may obtain, an indication of a target TDM schedule of the RIS 160. For example, the target TDM schedule may indicate how TDM resources of the RIS 160 are and/or will be multiplexed. Transmitting and obtaining the indication of a target TDM schedule of the RIS 160 may enable the network node 110 to allocate TDM resources for each UE (e.g., for UEs 120a and 120b). In some examples, the network node 110 may generate a TDM schedule and indicate the TDM schedule to one or more UEs.

As indicated above, FIG. 20 is provided as an example. Other examples may differ from what is described with respect to FIG. 20.

In some examples, a quantity of the plurality of UEs that may control the RIS 160 satisfies (e.g., is less than or equal to) a threshold quantity of UEs (denoted by M). M may represent the maximum number of UEs that are permitted to share the RIS 160. The network node 110 may not authorize additional UEs to control the RIS 160 when the current quantity of authorized UEs satisfies M. The quantity of the plurality of UEs that may control the RIS 160 satisfying M may help to ensure that the RIS 160 can support the plurality of UEs.

In some aspects, the RIS 160 may serve the plurality of UEs using a plurality of SDM resources (e.g., as discussed above in connection with example 2000 of FIG. 20). The quantity of the plurality of UEs may be based at least in part on one or more metrics associated with qualities of connections involving the plurality of UEs (e.g., network connections between the UEs and the network node 110). For example, M may be limited by connection quality indicators (e.g., RSRP, RSRQ, RSSI, signal-to-interference-plus-noise ratio (SINR), bit error rate (BER), block error rate (BLER), or the like).

When the quantity of UEs sharing the RIS 160 increases, the RIS 160 may split the RIS array into more parts, where each part includes fewer RIS elements and less beamforming gain. As a result, the signal strength for each UE (e.g., each authorized UE) may decrease. The network node 110 may determine the value of M based on UE reports of connection qualities. Based on the lowest connection quality among all the UEs (e.g., all the authorized UEs) not satisfying (e.g., being lower than) a connection quality threshold, the network node 110 may set the quantity of UEs permitted to control the RIS 160 (e.g., the quantity of authorized UEs) as M. Basing the quantity of the plurality of UEs at least in part on one or more metrics associated with connection qualities of connections involving the plurality of UEs may help to ensure that the plurality of UEs retain connections having a target level of quality (e.g., as estimated or measured by the one or more metrics).

In some aspects, the RIS 160 may serve the plurality of UEs using a plurality of TDM resources (e.g., as discussed above in connection with example 2010 of FIG. 20). The quantity of the plurality of UEs may be based at least in part on delays associated with connections involving the plurality of UEs (e.g., network connections between the UEs and the network node 110). When the quantity of UEs sharing the RIS 160 increases, the RIS 160 may use a longer TDM period. As a result, the waiting time for each UE (e.g., each authorized UE) to be served by the RIS 160 may increase. The network node 110 may determine the value of M based on UE traffic delay. Based on the largest traffic delay among all the UEs (e.g., all the authorized UEs) not satisfying (e.g., being lower than) a traffic delay threshold, the network node 110 may set the quantity of UEs permitted to control the RIS 160 (e.g., the quantity of authorized UEs) as M. Basing the quantity of the plurality of UEs at least in part on delays associated with connections involving the plurality of UEs may help to ensure that the plurality of UEs retain connections having a target level of traffic expediency.

In some examples, the network node 110 may authorize one UE at a time. For example, the network node 110 may not authorize a UE until an authorization of a current RIS-controlling UE has been released.

FIG. 21 is a diagram illustrating an example process 2100 performed, for example, by a UE, in accordance with the present disclosure. Example process 2100 is an example where the UE (e.g., UE 120) performs operations associated with UE control of a RIS.

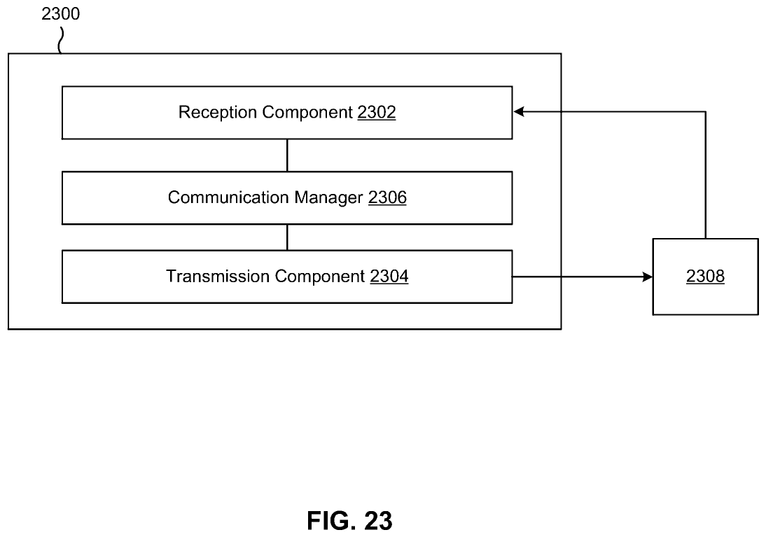

As shown in FIG. 21, in some aspects, process 2100 may include receiving, from a network node via a RIS, an SSB (block 2110). For example, the UE (e.g., using reception component 2302 and/or communication manager 2306, depicted in FIG. 23) may receive, from a network node via a RIS, an SSB, as described above.

As further shown in FIG. 21, in some aspects, process 2100 may include establishing, based at least in part on receiving the SSB, a network connection with the network node, wherein establishing the network connection includes performing a random access procedure via the RIS and transmitting a control signal for controlling the RIS (block 2120). For example, the UE (e.g., using communication manager 2306, depicted in FIG. 23) may establish, based at least in part on receiving the SSB, a network connection with the network node, wherein establishing the network connection includes performing a random access procedure via the RIS and transmitting a control signal for controlling the RIS, as described above. The random access procedure may be a four-step random access procedure or a two-step random access procedure, as discussed above in connection with FIGS. 16 and 17. The control signal may be an indication for the RIS to hold a pair of RIS beams, including a network-side beam and a UE-side beam.

Process 2100 may include additional aspects, such as any single aspect or any combination of aspects described below and/or in connection with one or more other processes described elsewhere herein.

In a first aspect, transmitting the control signal includes transmitting the control signal based at least in part on an authorization to control the RIS.

In a second aspect, alone or in combination with the first aspect, receiving the SSB includes receiving the SSB over a pair of RIS beams, including a network-side beam and a UE-side beam, that is held for a time interval that is greater than or equal to an SSB period.

In a third aspect, alone or in combination with one or more of the first and second aspects, performing the random access procedure includes transmitting a first message of the random access procedure requesting the authorization to control the RIS, and receiving a second message of the random access procedure that includes an authorization key that provides the authorization to control the RIS.

In a fourth aspect, alone or in combination with one or more of the first through third aspects, the first message is associated with a RA-RNTI that is associated with requesting the authorization to control the RIS.

In a fifth aspect, alone or in combination with one or more of the first through fourth aspects, the first message is associated with a random access channel that is associated with requesting the authorization to control the RIS.

In a sixth aspect, alone or in combination with one or more of the first through fifth aspects, the control signal is an indication for the RIS to hold a pair of RIS beams, including a network-side beam and a UE-side beam, transmitting the control signal includes transmitting the control signal based at least in part on the authorization key, and process 2100 includes transmitting, based at least in part on transmitting the control signal, a third message of the random access procedure, and receiving a fourth message of the random access procedure.

In a seventh aspect, alone or in combination with one or more of the first through sixth aspects, transmitting the third message of the random access procedure includes transmitting the third message of the random access procedure within a configured timeout window.

In an eighth aspect, alone or in combination with one or more of the first through seventh aspects, the RIS is configured to perform a beam-sweeping procedure based at least in part on whether a RIS controller associated with the RIS has received an indication of a direction of the network node.

In a ninth aspect, alone or in combination with one or more of the first through eighth aspects, the authorization to control the RIS expires based at least in part on one or more of a threshold time period associated with the authorization to control the RIS, a threshold amount of traffic associated with the authorization to control the RIS, or a priority associated with the UE.

In a tenth aspect, alone or in combination with one or more of the first through ninth aspects, process 2100 includes receiving an indication that the authorization to control the RIS has expired.

In an eleventh aspect, alone or in combination with one or more of the first through tenth aspects, process 2100 includes transmitting a request to release the authorization to control the RIS.

In a twelfth aspect, alone or in combination with one or more of the first through eleventh aspects, process 2100 includes receiving an indication of a RIS beam-sweeping period, and the SSB is associated with an SSB index that is based at least in part on the RIS beam-sweeping period.

In a thirteenth aspect, alone or in combination with one or more of the first through twelfth aspects, the RIS is configured to be controlled by a plurality of UEs including the UE.

In a fourteenth aspect, alone or in combination with one or more of the first through thirteenth aspects, process 2100 includes transmitting an indication of a target space division multiplexing state of the RIS.

In a fifteenth aspect, alone or in combination with one or more of the first through fourteenth aspects, process 2100 includes transmitting an indication of a target time division multiplexing schedule of the RIS.

In a sixteenth aspect, alone or in combination with one or more of the first through fifteenth aspects, the RIS serves the UEs using at least one first resource and performs a UE-side beam-sweeping procedure using at least one second resource.

In a seventeenth aspect, alone or in combination with one or more of the first through sixteenth aspects, a quantity of the plurality of UEs satisfies a threshold quantity of UEs.

In an eighteenth aspect, alone or in combination with one or more of the first through seventeenth aspects, the RIS serves the plurality of UEs using a plurality of SDM resources, and the quantity of the plurality of UEs is based at least in part on one or more metrics associated with qualities of connections involving the plurality of UEs.

In a nineteenth aspect, alone or in combination with one or more of the first through eighteenth aspects, the RIS serves the plurality of UEs using a plurality of TDM resources, and the quantity of the plurality of UEs is based at least in part on delays associated with connections involving the plurality of UEs.

Although FIG. 21 shows example blocks of process 2100, in some aspects, process 2100 may include additional blocks, fewer blocks, different blocks, or differently arranged blocks than those depicted in FIG. 21. Additionally, or alternatively, two or more of the blocks of process 2100 may be performed in parallel.

FIG. 22 is a diagram illustrating an example process 2200 performed, for example, by a network node, in accordance with the present disclosure. Example process 2200 is an example where the network node (e.g., network node 110) performs operations associated with UE control of a RIS.

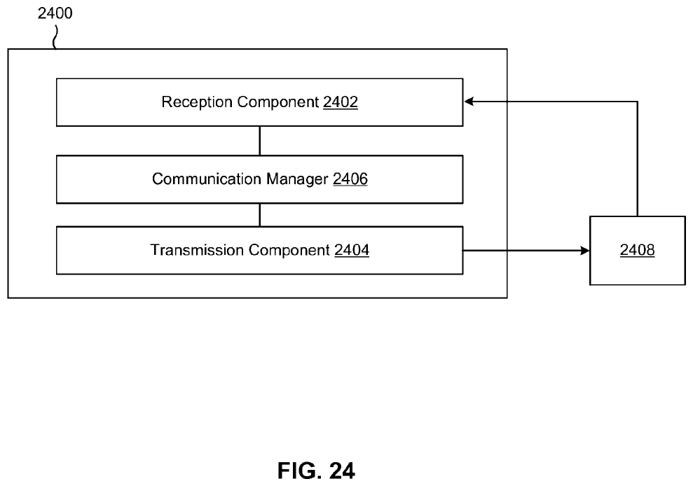

As shown in FIG. 22, in some aspects, process 2200 may include outputting an SSB (block 2210). For example, the network node (e.g., using transmission component 2404 and/or communication manager 2406, depicted in FIG. 24) may output an SSB, as described above.

As further shown in FIG. 22, in some aspects, process 2200 may include establishing, based at least in part on the SSB, a network connection with a UE, wherein establishing the network connection includes performing a random access procedure via a RIS configured to be controlled by the UE(block 2220). For example, the network node (e.g., using communication manager 2406, depicted in FIG. 24) may establish, based at least in part on the SSB, a network connection with a UE, wherein establishing the network connection includes performing a random access procedure via a RIS configured to be controlled by the UE, as described above. The random access procedure may be a four-step random access procedure or a two-step random access procedure, as discussed above in connection with FIGS. 16 and 17. The control signal may be an indication for the RIS to hold a pair of RIS beams, including a network-side beam and a UE-side beam.

Process 2200 may include additional aspects, such as any single aspect or any combination of aspects described below and/or in connection with one or more other processes described elsewhere herein.

In a first aspect, process 2200 includes providing an authorization for the UE to control the RIS.

In a second aspect, alone or in combination with the first aspect, performing the random access procedure includes obtaining a first message of the random access procedure requesting the authorization to control the RIS, and outputting a second message of the random access procedure that includes an authorization key that provides the authorization to control the RIS.

In a third aspect, alone or in combination with one or more of the first and second aspects, the RIS is configured to be controlled by a plurality of UEs including the UE.

Although FIG. 22 shows example blocks of process 2200, in some aspects, process 2200 may include additional blocks, fewer blocks, different blocks, or differently arranged blocks than those depicted in FIG. 22. Additionally, or alternatively, two or more of the blocks of process 2200 may be performed in parallel.

FIG. 23 is a diagram of an example apparatus 2300 for wireless communication, in accordance with the present disclosure. The apparatus 2300 may be a UE, or a UE may include the apparatus 2300. In some aspects, the apparatus 2300 includes a reception component 2302, a transmission component 2304, and/or a communication manager 2306, which may be in communication with one another (for example, via one or more buses and/or one or more other components). In some aspects, the communication manager 2306 is the communication manager 140 described in connection with FIG. 1. As shown, the apparatus 2300 may communicate with another apparatus 2308, such as a UE or a network node (such as a CU, a DU, an RU, or a base station), using the reception component 2302 and the transmission component 2304.

In some aspects, the apparatus 2300 may be configured to perform one or more operations described herein in connection with FIGS. 12-20. Additionally, or alternatively, the apparatus 2300 may be configured to perform one or more processes described herein, such as process 2100 of FIG. 21. In some aspects, the apparatus 2300 and/or one or more components shown in FIG. 23 may include one or more components of the UE described in connection with FIG. 2. Additionally, or alternatively, one or more components shown in FIG. 23 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2302 may receive communications, such as reference signals, control information, data communications, or a combination thereof, from the apparatus 2308. The reception component 2302 may provide received communications to one or more other components of the apparatus 2300. In some aspects, the reception component 2302 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2300. In some aspects, the reception component 2302 may include one or more antennas, a modem, a demodulator, a MIMO detector, a receive processor, a controller/processor, a memory, or a combination thereof, of the UE described in connection with FIG. 2.

The transmission component 2304 may transmit communications, such as reference signals, control information, data communications, or a combination thereof, to the apparatus 2308. In some aspects, one or more other components of the apparatus 2300 may generate communications and may provide the generated communications to the transmission component 2304 for transmission to the apparatus 2308. In some aspects, the transmission component 2304 may perform signal processing on the generated communications (such as filtering, amplification, modulation, digital-to-analog conversion, multiplexing, interleaving, mapping, or encoding, among other examples), and may transmit the processed signals to the apparatus 2308. In some aspects, the transmission component 2304 may include one or more antennas, a modem, a modulator, a transmit MIMO processor, a transmit processor, a controller/processor, a memory, or a combination thereof, of the UE described in connection with FIG. 2. In some aspects, the transmission component 2304 may be co-located with the reception component 2302 in a transceiver.

The communication manager 2306 may support operations of the reception component 2302 and/or the transmission component 2304. For example, the communication manager 2306 may receive information associated with configuring reception of communications by the reception component 2302 and/or transmission of communications by the transmission component 2304. Additionally, or alternatively, the communication manager 2306 may generate and/or provide control information to the reception component 2302 and/or the transmission component 2304 to control reception and/or transmission of communications.

The reception component 2302 may receive, from a network node via a RIS, an SSB. The communication manager 2306 may establish, based at least in part on receiving the SSB, a network connection with the network node, wherein establishing the network connection includes performing a random access procedure via the RIS and transmitting a control signal for controlling the RIS.

The reception component 2302 may receive an indication that the authorization to control the RIS has expired.

The transmission component 2304 may transmit a request to release the authorization to control the RIS.

The reception component 2302 may receive an indication of a RIS beam-sweeping period, wherein the SSB is associated with an SSB index that is based at least in part on the RIS beam-sweeping period.

The transmission component 2304 may transmit an indication of a target SDM state of the RIS.

The transmission component 2304 may transmit an indication of a target TDM schedule of the RIS.

The number and arrangement of components shown in FIG. 23 are provided as an example. In practice, there may be additional components, fewer components, different components, or differently arranged components than those shown in FIG. 23. Furthermore, two or more components shown in FIG. 23 may be implemented within a single component, or a single component shown in FIG. 23 may be implemented as multiple, distributed components. Additionally, or alternatively, a set of (one or more) components shown in FIG. 23 may perform one or more functions described as being performed by another set of components shown in FIG. 23.

FIG. 24 is a diagram of an example apparatus 2400 for wireless communication, in accordance with the present disclosure. The apparatus 2400 may be a network node, or a network node may include the apparatus 2400. In some aspects, the apparatus 2400 includes a reception component 2402, a transmission component 2404, and/or a communication manager 2406, which may be in communication with one another (for example, via one or more buses and/or one or more other components). In some aspects, the communication manager 2406 is the communication manager 150 described in connection with FIG. 1. As shown, the apparatus 2400 may communicate with another apparatus 2408, such as a UE or a network node (such as a CU, a DU, an RU, or a base station), using the reception component 2402 and the transmission component 2404.

In some aspects, the apparatus 2400 may be configured to perform one or more operations described herein in connection with FIGS. 12-20. Additionally, or alternatively, the apparatus 2400 may be configured to perform one or more processes described herein, such as process 2200 of FIG. 22. In some aspects, the apparatus 2400 and/or one or more components shown in FIG. 24 may include one or more components of the network node described in connection with FIG. 2. Additionally, or alternatively, one or more components shown in FIG. 24 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 2402 may receive communications, such as reference signals, control information, data communications, or a combination thereof, from the apparatus 2408. The reception component 2402 may provide received communications to one or more other components of the apparatus 2400. In some aspects, the reception component 2402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 2400. In some aspects, the reception component 2402 may include one or more antennas, a modem, a demodulator, a MIMO detector, a receive processor, a controller/processor, a memory, or a combination thereof, of the network node described in connection with FIG. 2. In some aspects, the reception component 2402 and/or the transmission component 2404 may include or may be included in a network interface. The network interface may be configured to obtain and/or output signals for the apparatus 2400 via one or more communications links, such as a backhaul link, a midhaul link, and/or a fronthaul link.

The transmission component 2404 may transmit communications, such as reference signals, control information, data communications, or a combination thereof, to the apparatus 2408. In some aspects, one or more other components of the apparatus 2400 may generate communications and may provide the generated communications to the transmission component 2404 for transmission to the apparatus 2408. In some aspects, the transmission component 2404 may perform signal processing on the generated communications (such as filtering, amplification, modulation, digital-to-analog conversion, multiplexing, interleaving, mapping, or encoding, among other examples), and may transmit the processed signals to the apparatus 2408. In some aspects, the transmission component 2404 may include one or more antennas, a modem, a modulator, a transmit MIMO processor, a transmit processor, a controller/processor, a memory, or a combination thereof, of the network node described in connection with FIG. 2. In some aspects, the transmission component 2404 may be co-located with the reception component 2402 in a transceiver.

The communication manager 2406 may support operations of the reception component 2402 and/or the transmission component 2404. For example, the communication manager 2406 may receive information associated with configuring reception of communications by the reception component 2402 and/or transmission of communications by the transmission component 2404. Additionally, or alternatively, the communication manager 2406 may generate and/or provide control information to the reception component 2402 and/or the transmission component 2404 to control reception and/or transmission of communications.

The transmission component 2404 may output an SSB. The communication manager 2406 may establish, based at least in part on the SSB, a network connection with a UE, wherein establishing the network connection includes performing a random access procedure via a RIS configured to be controlled by the UE.

The number and arrangement of components shown in FIG. 24 are provided as an example. In practice, there may be additional components, fewer components, different components, or differently arranged components than those shown in FIG. 24. Furthermore, two or more components shown in FIG. 24 may be implemented within a single component, or a single component shown in FIG. 24 may be implemented as multiple, distributed components. Additionally, or alternatively, a set of (one or more) components shown in FIG. 24 may perform one or more functions described as being performed by another set of components shown in FIG. 24.

The following provides an overview of some Aspects of the present disclosure:

Aspect 1: A method of wireless communication performed by a UE, comprising: receiving, from a network node via a RIS, an SSB; and establishing, based at least in part on receiving the SSB, a network connection with the network node, wherein establishing the network connection includes performing a random access procedure via the RIS and transmitting a control signal for controlling the RIS.

Aspect 2: The method of Aspect 1, wherein transmitting the control signal includes: transmitting the control signal based at least in part on an authorization to control the RIS.

Aspect 3: The method of Aspect 2, wherein receiving the SSB includes: receiving the SSB over a pair of RIS beams, including a network-side beam and a UE-side beam, that is held for a time interval that is greater than or equal to an SSB period.

Aspect 4: The method of Aspect 2, wherein performing the random access procedure includes: transmitting a first message of the random access procedure requesting the authorization to control the RIS; and receiving a second message of the random access procedure that includes an authorization key that provides the authorization to control the RIS.

Aspect 5: The method of Aspect 4, wherein the first message is associated with a RA-RNTI that is associated with requesting the authorization to control the RIS.

Aspect 6: The method of Aspect 4, wherein the first message is associated with a random access channel that is associated with requesting the authorization to control the RIS.

Aspect 7: The method of Aspect 4, wherein the control signal is an indication for the RIS to hold a pair of RIS beams, including a network-side beam and a UE-side beam, and wherein transmitting the control signal includes: transmitting the control signal based at least in part on the authorization key, the method further comprising: transmitting, based at least in part on transmitting the control signal, a third message of the random access procedure; and receiving a fourth message of the random access procedure.

Aspect 8: The method of Aspect 7, wherein transmitting the third message of the random access procedure includes: transmitting the third message of the random access procedure within a configured timeout window.

Aspect 9: The method of Aspect 2, wherein the RIS is configured to perform a beam-sweeping procedure based at least in part on whether a RIS controller associated with the RIS has received an indication of a direction of the network node.

Aspect 10: The method of Aspect 2, wherein the authorization to control the RIS expires based at least in part on one or more of: a threshold time period associated with the authorization to control the RIS; a threshold amount of traffic associated with the authorization to control the RIS; or a priority associated with the UE.

Aspect 11: The method of Aspect 2, further comprising: receiving an indication that the authorization to control the RIS has expired.

Aspect 12: The method of Aspect 2, further comprising: transmitting a request to release the authorization to control the RIS.

Aspect 13: The method of any of Aspects 1-12, further comprising: receiving an indication of a RIS beam-sweeping period, wherein the SSB is associated with an SSB index that is based at least in part on the RIS beam-sweeping period.

Aspect 14: The method of any of Aspects 1-13, wherein the RIS is configured to be controlled by a plurality of UEs including the UE.

Aspect 15: The method of Aspect 14, further comprising: transmitting an indication of a target space division multiplexing state of the RIS.

Aspect 16: The method of Aspect 14, further comprising: transmitting an indication of a target time division multiplexing schedule of the RIS.

Aspect 17: The method of Aspect 14, wherein the RIS serves the UEs using at least one first resource and performs a UE-side beam-sweeping procedure using at least one second resource.

Aspect 18: The method of Aspect 14, wherein a quantity of the plurality of UEs satisfies a threshold quantity of UEs.

Aspect 19: The method of Aspect 18, wherein the RIS serves the plurality of UEs using a plurality of space division multiplexing resources, and wherein the quantity of the plurality of UEs is based at least in part on one or more metrics associated with qualities of connections involving the plurality of UEs.

Aspect 20: The method of Aspect 18, wherein the RIS serves the plurality of UEs using a plurality of time division multiplexing resources, and wherein the quantity of the plurality of UEs is based at least in part on delays associated with connections involving the plurality of UEs.

Aspect 21: A method of wireless communication performed by a network node, comprising: outputting an SSB; and establishing, based at least in part on the SSB, a network connection with a UE, wherein establishing the network connection includes performing a random access procedure via a RIS configured to be controlled by the UE.

Aspect 22: The method of Aspect 21, further comprising: providing an authorization for the UE to control the RIS.

Aspect 23: The method of Aspect 22, wherein performing the random access procedure includes: obtaining a first message of the random access procedure requesting the authorization to control the RIS; and outputting a second message of the random access procedure that includes an authorization key that provides the authorization to control the RIS.

Aspect 24: The method of any of Aspects 21-23, wherein the RIS is configured to be controlled by a plurality of UEs including the UE.

Aspect 25: An apparatus for wireless communication at a device, comprising a processor; memory coupled with the processor; and instructions stored in the memory and executable by the processor to cause the apparatus to perform the method of one or more of Aspects 1-24.

Aspect 26: A device for wireless communication, comprising a memory and one or more processors coupled to the memory, the one or more processors configured to perform the method of one or more of Aspects 1-24.

Aspect 27: An apparatus for wireless communication, comprising at least one means for performing the method of one or more of Aspects 1-24.

Aspect 28: A non-transitory computer-readable medium storing code for wireless communication, the code comprising instructions executable by a processor to perform the method of one or more of Aspects 1-24.

Aspect 29: A non-transitory computer-readable medium storing a set of instructions for wireless communication, the set of instructions comprising one or more instructions that, when executed by one or more processors of a device, cause the device to perform the method of one or more of Aspects 1-24.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, andc+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A user equipment (UE) for wireless communication, comprising:
one or more memories; and
one or more processors, coupled to the one or more memories, configured to:
receive, from a network node via a reconfigurable intelligent surface (RIS), a synchronization signal block (SSB); and
establish, based at least in part on receiving the SSB, a network connection with the network node, wherein the one or more processors, to establish the network connection, are configured to perform a random access procedure via the RIS and transmit a control signal for controlling the RIS.

2. The UE of claim 1, wherein the one or more processors, to transmit the control signal, are configured to:
transmit the control signal based at least in part on an authorization to control the RIS.

3. The UE of claim 2, wherein the one or more processors, to receive the SSB, are configured to:
receive the SSB over a pair of RIS beams, including a network-side beam and a UE-side beam, that is held for a time interval that is greater than or equal to an SSB period.

4. The UE of claim 2, wherein the one or more processors, to perform the random access procedure, are configured to:
transmit a first message of the random access procedure requesting the authorization to control the RIS; and
receive a second message of the random access procedure that includes an authorization key that provides the authorization to control the RIS.

5. The UE of claim 4, wherein the first message is associated with a random access radio network temporary identifier (RA-RNTI) that is associated with requesting the authorization to control the RIS.

6. The UE of claim 4, wherein the first message is associated with a random access channel that is associated with requesting the authorization to control the RIS.

7. The UE of claim 4, wherein the control signal is an indication for the RIS to hold a pair of RIS beams, including a network-side beam and a UE-side beam, and wherein the one or more processors, to transmit the control signal, are configured to:
transmit the control signal based at least in part on the authorization key, wherein the one or more processors are further configured to:
transmit, based at least in part on transmitting the control signal, a third message of the random access procedure; and
receive a fourth message of the random access procedure.

8. The UE of claim 7, wherein the one or more processors, to transmit the third message of the random access procedure, are configured to:
transmit the third message of the random access procedure within a configured timeout window.

9. The UE of claim 2, wherein the RIS is configured to perform a beam-sweeping procedure based at least in part on whether a RIS controller associated with the RIS has received an indication of a direction of the network node.

10. The UE of claim 2, wherein the authorization to control the RIS expires based at least in part on one or more of:
a threshold time period associated with the authorization to control the RIS;
a threshold amount of traffic associated with the authorization to control the RIS; or
a priority associated with the UE.

11. The UE of claim 2, wherein the one or more processors are further configured to:
receive an indication that the authorization to control the RIS has expired.

12. The UE of claim 2, wherein the one or more processors are further configured to:
transmit a request to release the authorization to control the RIS.

13. The UE of claim 1, wherein the one or more processors are further configured to:
receive an indication of a RIS beam-sweeping period, wherein the SSB is associated with an SSB index that is based at least in part on the RIS beam-sweeping period.

14. The UE of claim 1, wherein the RIS is configured to be controlled by a plurality of UEs including the UE.

15. The UE of claim 14, wherein the one or more processors are further configured to:
transmit an indication of a target space division multiplexing state of the RIS.

16. The UE of claim 14, wherein the one or more processors are further configured to:
transmit an indication of a target time division multiplexing schedule of the RIS.

17. The UE of claim 14, wherein the RIS serves the UEs using at least one first resource and performs a UE-side beam-sweeping procedure using at least one second resource.

18. The UE of claim 14, wherein a quantity of the plurality of UEs satisfies a threshold quantity of UEs.

19-20. (canceled)

21. A network node for wireless communication, comprising:
one or more memories; and
one or more processors, coupled to the one or more memories, configured to:
output a synchronization signal block (SSB); and
establish, based at least in part on the SSB, a network connection with a user equipment (UE), wherein the one or more processors, to establish the network connection, are configured to perform a random access procedure via a reconfigurable intelligent surface (RIS) configured to be controlled by the UE.

22-24. (canceled)

25. A method of wireless communication performed by a user equipment (UE), comprising:
receiving, from a network node via a reconfigurable intelligent surface (RIS), a synchronization signal block (SSB); and
establishing, based at least in part on receiving the SSB, a network connection with the network node, wherein establishing the network connection includes performing a random access procedure via the RIS and transmitting a control signal for controlling the RIS.

26-30. (canceled)
